(19) United States
(12) Patent Application Publication
(10) Pub. No.: US 2012/0236825 A1
(43) Pub. Date: Sep. 20, 2012

(54) COMMUNICATION TERMINAL DEVICE, HANDOVER CONTROL METHOD, AND RECORDING MEDIUM FOR HANDOVER CONTROL PROGRAM

(75) Inventor: Katsumi Otsuka, Kawasaki (JP)

(73) Assignee: FUJITSU LIMITED, Kawasaki-shi (JP)

(21) Appl. No.: 13/433,807

(22) Filed: Mar. 29, 2012

Related U.S. Application Data
(63) Continuation of application No. PCT/JP2009/067433, filed on Oct. 6, 2009.

(51) Int. Cl. H04W 36/24; H04W 24/00

(52) U.S. Cl. 370/331

(57) ABSTRACT

A communication terminal device to be connected to an access point to conduct communications using voice/sound packet data, the communication terminal device includes a jitter monitor monitoring a jitter of the voice/sound packet data received from a connecting access point; and a handover cause generator generating a handover cause to change a connection from the connecting access point to another access point based on a number of jitters exceeding an allowable value in a predetermined time period.

### CROSS-REFERENCE TO RELATED APPLICATION

This application is a continuation application filed under 35 USC 111(a) claiming benefit under 35 USC 120 and 365(c) of PCT Application JP2009/067433 filed Oct. 6, 2009, the entire contents of which are incorporated herein by reference.

### FIELD

The embodiment discussed herein is related to a handover of a radio terminal device between access points.

### BACKGROUND

In a communication terminal device such as a cellular phone device, in addition to a function as an existing communication unit, Voice over Internet Protocol (VoIP) communications using a wireless Local Area Network have been put into practical use. In a VoIP communication environment, to avoid a delay or a retransmission of voice packet data (i.e., Real-time Transport Protocol (RTP) packet data), plural Access Points (APs) are disposed in the environment area.

In normal (conventional) data communications, as long as packet data are received from the Access point (AP), necessary information is acquired even when the data were delayed or retransmitted. However, in the VoIP communications, the delay or the retransmission of the voice packet data may influence the voice quality.

In the VoIP communications, in the AP, Quality of Service (QoS) (i.e., communication quality of Bit Error Rate (BER) and the like) control is executed to apply a priority order to transmission packets.

Under a VoIP environment, the voice packet data is categorized as AC3 (AC_VO) indicating a higher priority order. Therefore, when transmission packet data are accumulated in the AP, the data packets not only having been delayed but also having been accumulated may be transmitted in a shorter time period. This may cause a jitter in the voice packet data.

The increase of workload in an AP may be influenced by the number of cellular phone devices belonging to the AP. To distribute (reduce) the workload of the AP, the AP may include a call admission control (CAC) function. When the CAC function is used, the number of voice calls may be limited to a predetermined value. However, the cost of the AP having the CAC function may become higher.

With respect to the jitter in received packet data, there has been known (see, for example, Japanese National Publication of International Patent Application No. 2008-516562) a dejitter buffer provided on the receiver side so as to adjust the size of the jitter and execute a sizing process for the packet data estimated by a participating station before the reception of the packet data.

Further, there has been known (see, for example, Japanese Patent Laid-open Publication No. 2008-35543) that a handover is executed between network entities.

### SUMMARY

According to an aspect, a communication terminal device to be connected to an access point to conduct communications using voice/sound packet data includes a jitter monitor monitoring a jitter of the voice/sound packet data received from a connecting access point; and a handover cause generator generating a handover to cause changing a connection from the connecting access point to another access point based on a number of jitters exceeding an allowable value in a predetermined time period.

The objects and advantages of the embodiments disclosed herein will be realized and attained by means of the elements and combinations particularly pointed out in the claims.

It is to be understood that both the foregoing general description and the following detailed description are exemplary and explanatory and are not restrictive of the invention as claimed.

### BRIEF DESCRIPTION OF DRAWINGS

FIG. 1 is examples of a communication terminal device and a wireless LAN system according to a first embodiment of the present application;

FIG. 2 is an example flowchart of a handover process according to the first embodiment;

FIG. 3 illustrates examples of a communication terminal device and a wireless LAN system according to a second embodiment of the present application;

FIG. 4 is an example flowchart of a handover process according to the second embodiment;

FIG. 5 is an example wireless LAN system according to a third embodiment;

FIG. 6 schematically illustrates an example where excessive handover may occur when handover is determined based on an RSSI value.

FIG. 7 is an example functional block diagram of a communication terminal device according to a third embodiment;

FIG. 8 is an example functional block diagram of a wireless section and the like in the communication terminal device;

FIG. 9 is an example exterior configuration of the communication terminal device;

FIG. 10 is an example categorization of the packet data in QoS control;

FIG. 11 is an example graph illustrating a relationship between received RTP jitter and handover;

FIG. 12 illustrates an example simulation of RTP packet intervals when a workload is increased;

FIG. 13 is an example flowchart of a handover process;

FIG. 14 is an example flowchart of measuring jitter of received RTP packet data;

FIG. 15 is an example flowchart of executing the handover;

FIG. 16 illustrates an example of a cellular phone device according to a fourth embodiment;

FIG. 17 is an example flowchart of measuring the jitter of the RTP packet data;

FIG. 18 is an example flowchart of a handover process;

FIG. 19 is an example flowchart of measuring a retransmission rate of RTP transmission in a communication terminal device according to a fifth embodiment of the present application;

FIG. 20 is an example flowchart of a handover process;

FIG. 21 is an example flowchart of a handover process according to another embodiment;

FIG. 22 is an example functional block diagram of a communication terminal device according to another embodiment;

FIG. 23 is an example flowchart of a handover process according to another embodiment;

FIG. 24 is an example flowchart of a handover process according to another embodiment;

FIG. 25 is an example personal digital assistant according to another embodiment; and

FIG. 26 is an example personal computer according to another embodiment.

### DESCRIPTION OF EMBODIMENTS

The handover is executed based on the strength (specifically, the strength of an electric field, i.e., a Received Signal Strength Indicator (RSSI) value) of radio waves transmitted from access points (APs). Namely, jitter of the voice packet data may not be practically considered. This may be because it has been thought that there is a proportional relationship between the RSSI value (the strength of radio waves) and the quality of voice/sound.

However, this relationship may not be a perfect proportional relationship. Therefore, in a case where the handover is executed based on the RSSI value, even when sufficient voice/sound quality is maintained, if the RSSI value is degraded, the handover is executed. Further, as long as sufficient RSSI value is maintained, even if the voice/sound quality is degraded, the handover is not executed.

Further, in a case where a communication terminal device is disposed between two access points (APs), when, for example, the strengths of the radio waves from the APs are near the threshold values, the radio waves may have jitter. In this case, even though the voice/sound quality is not degraded, a handover process may be repeated, which may cause the degradation of the voice/sound quality.

### First Embodiment

In an first embodiment, a jitter of voice packet data (voice/sound packet data) is monitored, and based on the frequency times of the jitters, a handover cause is generated.

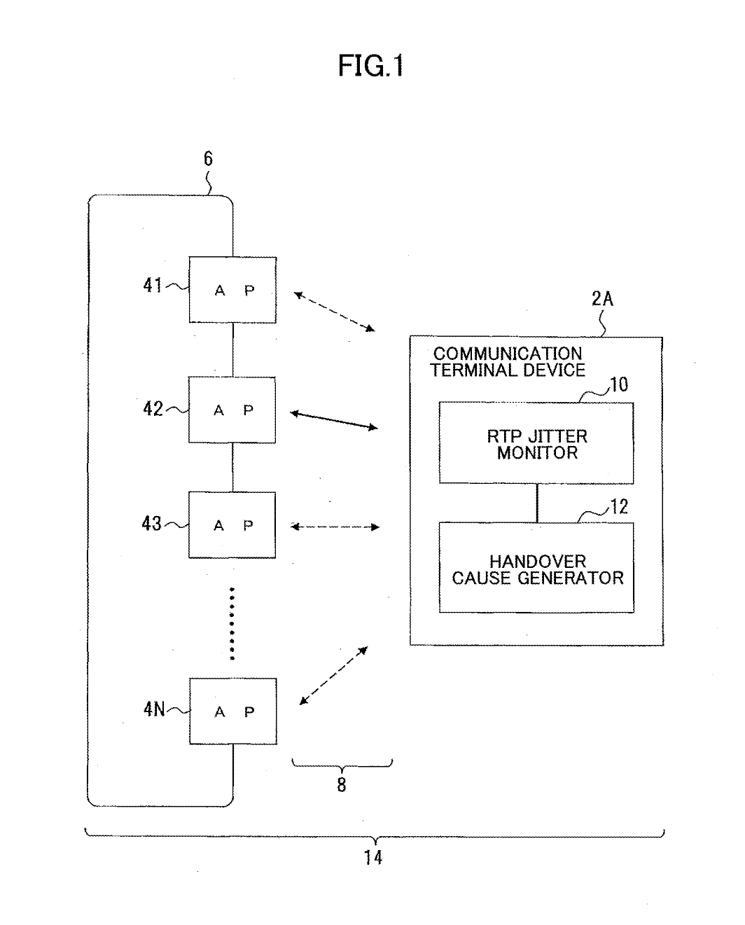

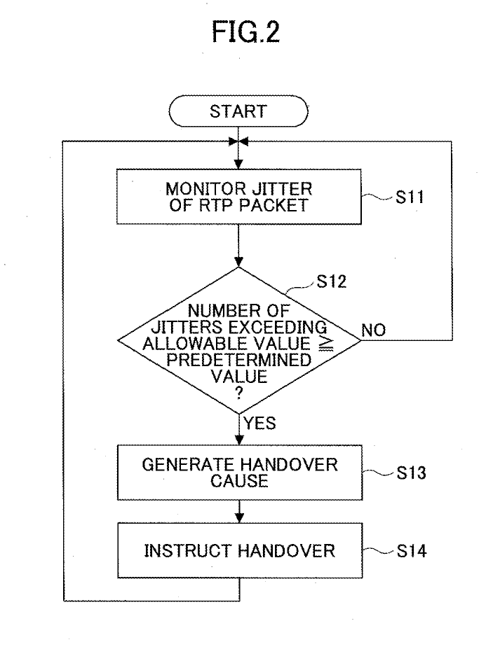

The first embodiment is described in detail with reference to FIGS. 1 and 2. FIG. 1 is an example communication terminal device according to the first embodiment. FIG. 2 is an example flowchart of generating the handover cause. The configurations illustrated in FIGS. 1 and 2 are explanatory purposes only, and the present invention is not limited to the configurations.

A communication terminal device 2A as illustrated in FIG. 1 is an example of a communication terminal device, a handover control method, or a handover control program according to an embodiment, wirelessly connected to any of access points (hereinafter may be simplified as “AP” or “APs”) 41, 42, 43, . . . , and 4N, and is an cellular phone device, a Personal Digital Assistant (PDA), or the like that is in communication with any of the APs using a voice packet data (Real-time Transport Protocol (RTP) packet data).

The AP 41, 42, 43, . . . , and 4N are coordinated (linked) via a network 6, and are an example relay means for relaying transmission and receiving packet data between the communication terminal device 2A and a not-shown communication device (communication terminal device).

Further, as a communication medium between the communication terminal device 2A and plural APs 41, 42, 43, . . . , and 4N, a wireless Local Area Network (LAN) for wireless connection using radio waves is provided, so as to allow Voice over Internet Protocol (VoIP) communications. Under such a VoIP communication environment, as illustrated in FIG. 1, the communication terminal device 2A includes an RTP jitter monitor (hereinafter may be simplified as a “jitter monitor”) 10 and a handover cause generator 12. The elements described above constitute a wireless LAN system 14.

The jitter monitor 10 is an example monitoring means for monitoring a jitter of the RTP packet data received from connecting AP 4x (i.e., any of the APs 41, 42, 43, . . . , and 4N). The jitter monitor 10 outputs the jitter monitor output to the handover cause generator 12. For example, when the communication terminal device 2A is wirelessly connected to the AP 42, the AP 42 may be connected to a communication terminal device other than the communication terminal device 2A.

Further, the other APs 41, 43, . . . , and 4N may be connected to respective communication terminal devices other than the communication terminal device 2A. The communication terminal device 2A may transmit and receive the RTP packet data via the AP 42 to and from a not shown communication terminal device via the AP 42 and the network 6 to the other AP. Here, the jitter monitor 10 may monitor the jitter of the RTP packet data reported by the radio wave from the AP 42.

The handover cause generator 12 receives the jitter monitor output and may generate a handover cause depending on the frequency times of the jitters exceeding an allowable range (value) within a predetermined time period. The handover cause herein refers to a cause (trigger) to execute the handover. In this case, the handover cause is reported from the communication terminal device 2A to the connecting AP 4x (=AP 42).

Further, herein, the term handover refers to switching from a connecting AP to another AP to be connected. For example, when the handover is executed, the connecting destination is switched from the connecting AP 4x to another AP 4y (i.e., any one of AP 41, AP 43, . . . , AP 4N).

The process of generating the handover cause of FIG. 2 is an example method or program of controlling the handover according to this embodiment. As illustrated in FIG. 2, the process includes a jitter monitoring function (step S11), a determination function of jitter frequency times (step S12), a generation function of the handover cause (step S13), and a handover instruction function (step S14).

More specifically, in the jitter monitoring function, the jitter of the received RTP packet data is monitored and measured (step S11). In the determination function of jitter frequency times, based on a result of the measured jitter, it is determined whether the frequency times (the number of times) of the jitters exceeding an allowable value is greater than or equal to a predetermined value (step S12).

When determined that the frequency times of the jitters exceeding an allowable value is greater than or equal to a predetermined value (YES in step S12), the process goes to step S13. In the generation function of the handover cause, the handover cause is generated (step S13). In the handover instruction function, based on the generation of the handover cause, the communication terminal device 2A sends an instruction to the connecting AP to execute the handover (step S14).

In the configuration described above, the jitter monitor 10 of the communication terminal device 2A, the jitter of the RTP packet data received by the communication terminal device 2A from the connecting AP 42, and the jitter monitor output is output (reported) to the handover cause generator 12.

In the handover cause generator 12, the handover cause is generated based on the frequency times of the jitters exceeding the allowable value. Based on the generated handover cause, the connecting destination is switched from the connecting AP 42 to any one of APs 41, 43, . . . , and 4N.

The jitter of the RTP packet data from the AP may be caused by the overload of the connecting AP, and cause the degradation of the voice/sound in the VoIP communications. Therefore, by determining the execution of the handover based on the frequency times of the jitters exceeding the allowable value, it may become possible to reduce the workloads of the AP and distribute the workload between the APs.

Further, it may become possible to prevent the degradation of the voice/sound in the VoIP communications, and improve the voice/sound quality. As a result, it may become possible to contribute to reliability of the connection with the AP, and realizes high-quality voice calls.

Further, it may become possible to instruct executing the handover from the communication terminal device 2A side to the connecting AP.

Further, it may become possible to avoid the inconvenience that as long as the RSSI value is sufficient, even if the voice/sound quality is degraded, the handover is not executed when the RSSI value is (mainly) used as the reference (a factor to determine whether the handover is to be executed).

Further, it may become possible to prevent the degradation of the voice/sound quality caused by the repetition of the handover.

### Second Embodiment

In a second embodiment, the handover is executed based on both the handover cause based on the degradation of the radio quality such as the RSSI value and the handover cause based on the frequency times of the jitters of the RTP packet data.

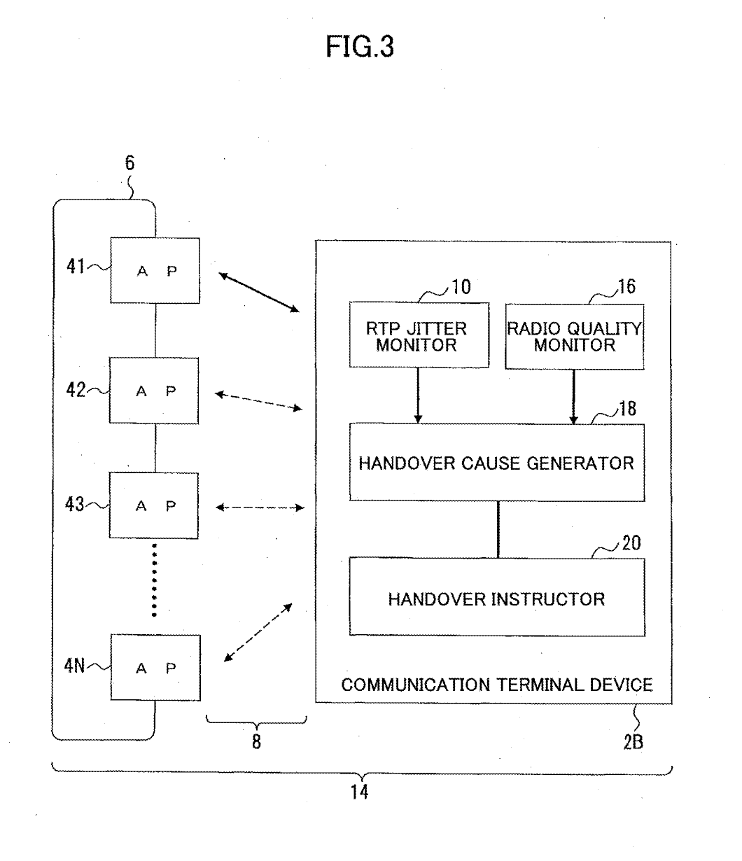

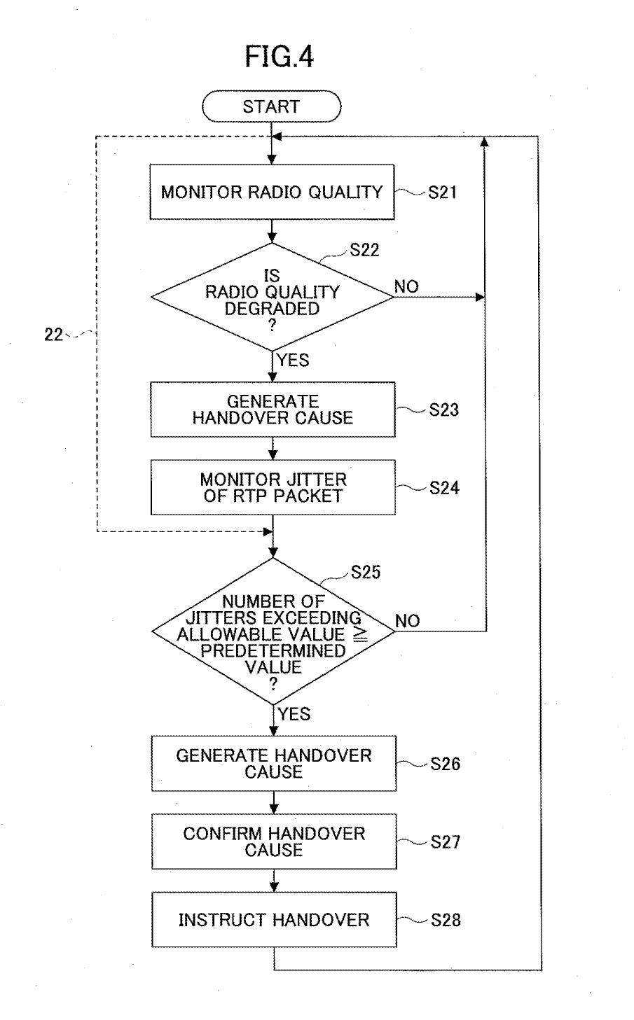

The second embodiment is described in detail with reference to FIGS. 3 and 4. FIG. 3 is an example communication terminal device according to the second embodiment. FIG. 4 is an example flowchart of generating the handover cause. The configurations illustrated in FIGS. 3 and 4 are explanatory purposes only, and the present invention is not limited to the configurations.

In a communication terminal device 2A, both the handover cause based on the degradation of the radio quality such as the RSSI value and the handover cause based on the frequency times of the jitters of the RTP packet data are (combinedly) used.

To that end, as illustrated in FIG. 3, the communication terminal device 2A includes the jitter monitor 10 described above, a radio quality monitor 16, a handover cause generator 18, and a handover instructor 20.

The description of the jitter monitor 10 is similar to that in the first embodiment. Therefore, the repeated description is omitted. However, the monitor output from the jitter monitor 10 is output (reported) to the handover cause generator 18.

The radio quality monitor 16 monitors at least one of a degradation of the RSSI value, a retransmission rate of the RTP transmission, a degradation of a Signal-to-Noise ratio (SN ratio), and any other radio quality indicator (radio quality). The monitor output from the radio quality monitor 16 is output to the handover cause generator 18.

In the handover cause generator 18, based on those monitor outputs, namely, by using the monitor output from the radio quality monitor 16 and the monitor output from the jitter monitor 10, the handover cause is generated.

In this case, even when the monitor output from the radio quality monitor 16 indicates a poor condition, as long as the monitor output from the jitter monitor 10 indicates a good condition, it may not be necessary to generate the handover cause.

On the other hand, even when the monitor output from the radio quality monitor 16 indicates a good condition, as long as the monitor output from the jitter monitor 10 indicates a poor condition, the handover cause is generated.

In the handover instructor 20, in response to the receipt of the report indicating the generation of the handover cause, an output indicating the handover instruction is generated. Based on the output, the handover is executed by switching the connection from the connecting AP (e.g., AP 41) to another AP (e.g., AP 42).

The process of generating the handover cause of FIG. 4 is an example method or program of controlling the handover according to this embodiment. As illustrated in FIG. 4, the process includes a radio quality monitoring function (step S21), a determination function of degradation of the radio quality (step S22), a generation function of the handover cause due to the degradation of the radio quality (step S23), a jitter monitoring function of the RTP packet data (step S24), a determination function of jitter frequency times (step S25), a generation function of the handover cause due to the jitter (step S26), a handover cause confirmation function (step S27), and a handover instruction function (step S28).

More specifically, in the radio quality monitoring function, at least one of the degradation of the RSSI value, the retransmission rate of the RTP transmission, the degradation of the SN ratio (SNR), and any other radio quality indicator is monitored (step S21).

In the determination function of degradation of the radio quality, based on a result of the monitoring result, it is determined whether the degradation (or the rate) exceeds the allowable value (step S22). When determining that the degradation (or the rate) exceeds the allowable value (YES in step S22), the process goes to step S23. In the generation function of the handover cause due to the degradation of the radio quality, the handover cause due to the degradation of the radio quality is generated (step S23).

Further, in the jitter monitoring function, the jitter of the received RTP packet data is monitored and measured (step S24). In the determination function of jitter frequency times, based on a result of the measured jitter, it is determined whether the frequency times (the number of times) of the jitters exceeding an allowable value is greater than or equal to a predetermined value (step S25).

When determined that the frequency times of the jitters exceeding an allowable value is greater than or equal to a predetermined value (YES in step S25), the process goes to step S26.

In the generation function of the handover cause, the handover cause due to the jitter of the RTP packet data is generated (step S26). In the handover cause confirmation function, the handover cause is confirmed (step S27).

In the handover instruction function, based on the generation of the handover cause, the communication terminal device 2B sends an instruction to the connecting AP to execute the handover (step S28). By doing this, the handover is executed, and the process goes back to step S21.

In the configuration described above, similar to the first embodiment, it may become possible to distribute the workload between the APs and improve the quality of the voice/sound data communications using the RTP packet data.

Further, in a case where the handover is executed based on a result of monitoring radio quality (e.g., the degradation of the RSSI value), even when the radio quality is degraded and if the voice/sound quality is not degraded, the handover is not executed.

As a result, it may become possible to avoid the repetition of the handover base on the radio quality. Further, when the radio quality is used as a reference, it may become possible to reduce the degradation of the voice/sound quality due to the repetition of the handover when the communication terminal device is disposed between APs and the strengths of the radio waves from the APs are near the threshold values.

In this embodiment, as illustrated in FIG. 4, after the degradation of the radio resource is monitored, the jitter of the RTP packet data is monitored. However, as illustrated in a dotted line 22 of FIG. 4, the jitter of the RTP packet data and the degradation of the radio resources may be simultaneously monitored.

In this case, instead of using the logical “AND” condition of those monitoring results, the logical “OR” condition of those monitoring results may be used to generate the handover cause.

### Third Embodiment

In a third embodiment, while the degradation of the radio quality (e.g., the degradation of the RSSI value) is monitored, the handover cause is generated based on the frequency times of the jitters of the RTP packet data, and the handover is executed. Namely, the handover cause is generated based on the logical “AND” condition of the degradation of the radio resource and the frequency times of the jitter of the RTP packet data.

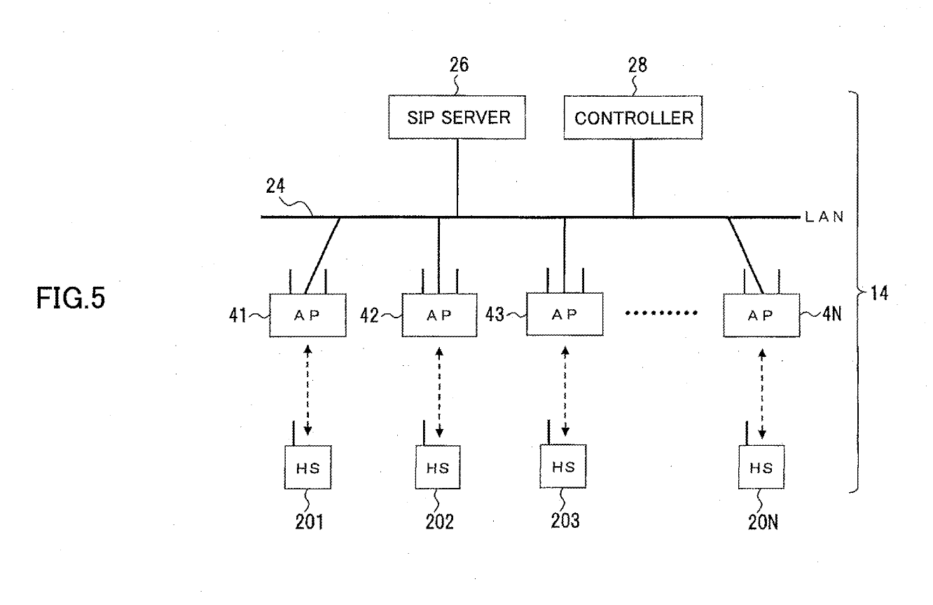

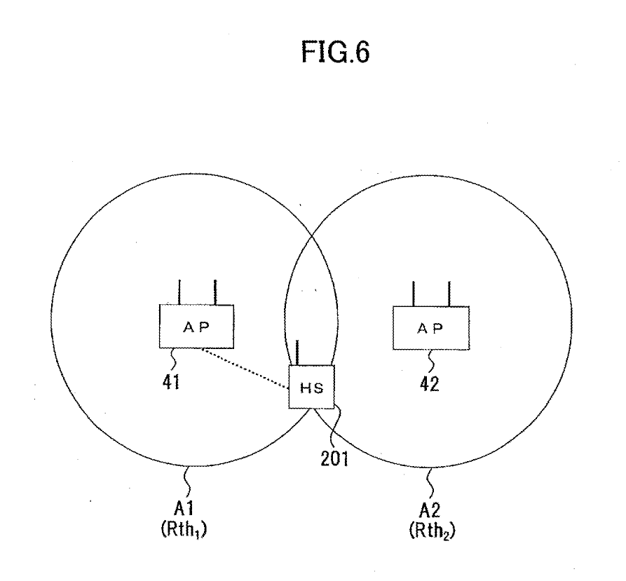

The third embodiment is described in detail with reference to FIGS. 5 and 6. FIG. 5 illustrates an example wireless LAN system according to this embodiment.

FIG. 6 schematically illustrates an example handover when a communication terminal device is disposed in an area where the strengths of the radio waves (i.e., the RSSI value) from the APs are near the threshold values. The configurations illustrated in FIGS. 5 and 6 are explanatory purposes only, and the present invention is not limited to the configurations.

As illustrated in FIG. 5, a wireless LAN system 14 includes the plural APs 41, 42, 43, . . . , and 4N. Further, the plural APs 41, 42, 43, . . . , and 4N are wirelessly connected to the cellular phone devices (HS) 201, 202, 203, . . . , and 20N, respectively. The APs 41, 42, 43, . . . , and 4N are connected to each other via LAN cables, so as to constitute a wired LAN 24.

Further, a Session Initiation Protocol (SIP) server 26 and a controller 28 are connected to the wired LAN 24. The SIP server 26 is an example control means for associating telephone numbers and IP addresses and call control to call the other side based on a protocol called SIP.

The controller 28 is an example control means for maintaining the connections between the APs 41, 42, 43, . . . , and 4N and the cellular phone devices (HS) 201, 202, 203, . . . , and 20N and performing various control functions such as data transfer.

Under such a VoIP communication environment, the plural APs 41, 42, 43, . . . , and 4N are provided. However, for example, there may be case where, for example, the cellular phone device (HS) 201 is disposed in an area (hereinafter may be referred to as an “overlapped connectable area”) where the area where a cellular phone device may be connected to the AP 41 and the area where a cellular phone device may be connected to the AP 42 are overlapped.

The symbols A1 and A2 denote the handover threshold values Rth₁ and Rth₂ of the RSSI values of the APs 41 and 42, respectively. Namely, in the circles of A1 and A2, the cellular phone may connect to the APs 41 and 42, respectively. Herein, the term handover threshold value of the RSSI value refers to a limit value of the strength value of the radio waves by which a cellular phone device (i.e., the communication terminal device) may connect to the corresponding AP.

When the cellular phone device (HS) 201 is disposed in the overlapped connectable area where the strength values of the radio waves from the APs 41 and 42 are greater than or equal to the handover threshold values Rth₁ and Rth₂, respectively, of the RSSI values, the handover cause due to the RSSI values may be generated frequently.

In this case, the connection between the AP 41 and the cellular phone device (HS) 201 and the connection between the AP 42 and the cellular phone device (HS) 201 may be frequently switched from one to another. As a result, the connecting condition between the cellular phone device (HS) 201 and the AP may become unstable. For example, when the connecting AP of the cellular phone device (HS) 201 is switched (changed) from AP 41 to AP 42 or from AP 42 to AP 41, the voice/sound quality in the VoIP communications may be influenced (degraded).

As a result, the workloads of the APs 41 and 42 may change from moment to moment. Also, in the cellular phone device (HS) 201, a jitter is generated in the received RTP packet data, an unstable connecting condition is generated, and abnormal noise may be generated due to the frequent connection change.

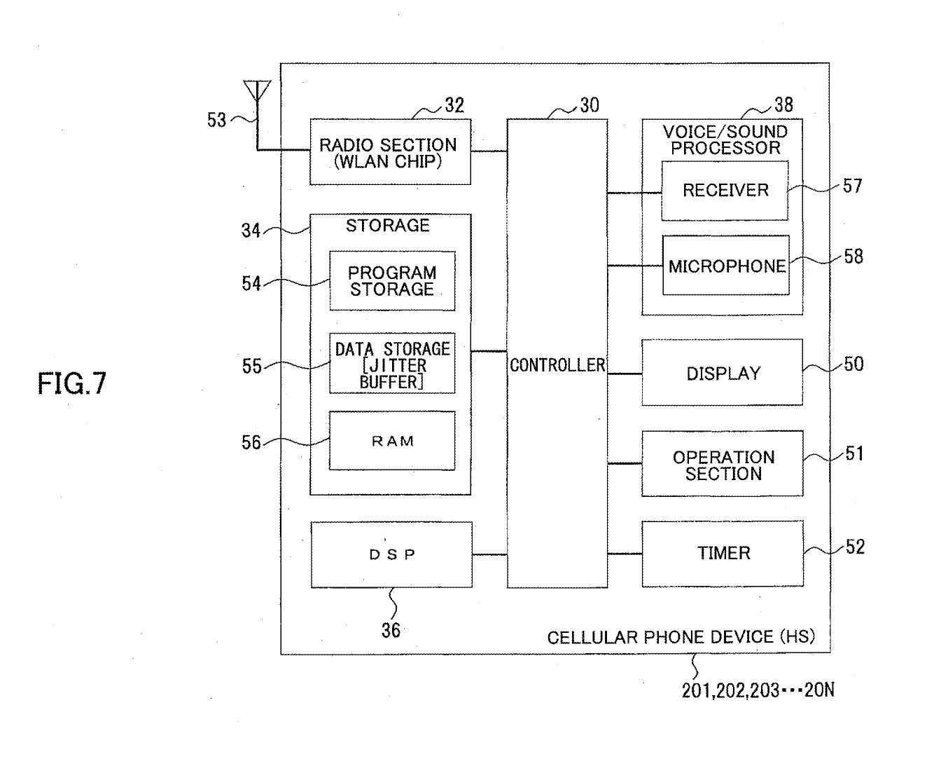

Next, the cellular phone devices (HS) 201, 202, 203, . . . , and 20N are described in detail with reference to FIGS. 7 through 9. FIG. 7 illustrates an example configuration of the cellular phone device.

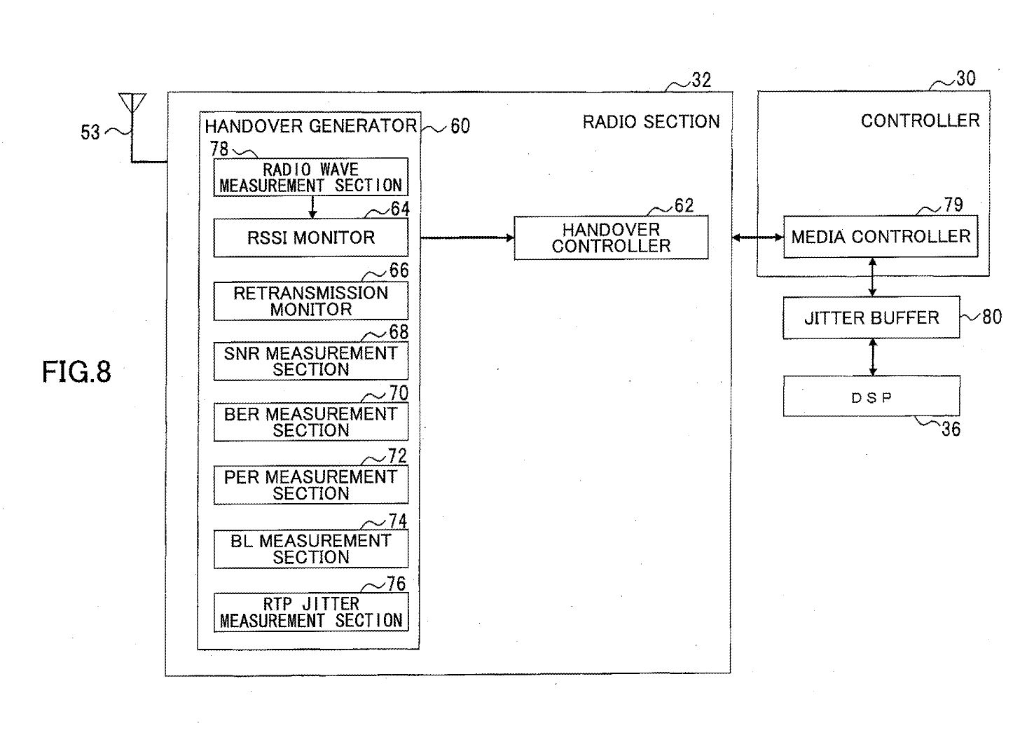

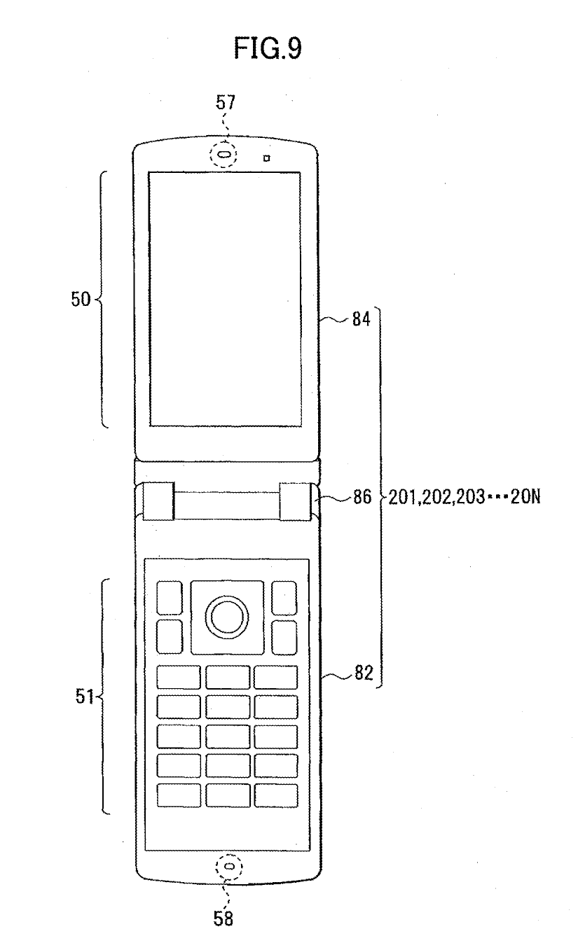

FIG. 8 illustrates an example of a functional section of a radio section. FIG. 9 illustrates an example external configuration of the cellular phone device. The configurations illustrated in FIGS. 7 through 9 are for explanatory purposes only, and the present invention is not limited to the configurations.

In FIGS. 7 through 9, the same reference numerals are used to describe the same elements as those in FIG. 1, and the repeated descriptions thereof may be omitted.

The cellular phone devices (HS) 201, 202, 203, . . . , and 20N are examples of a communication terminal device, a handover control method, and a handover control program according to an embodiment of the present application, and are able to perform the VoIP communications using the wireless LAN.

Here, the cellular phone devices (HS) 201, 202, 203, . . . , and 20N include a controller 30, a radio section 32, a storage 34, a Digital Signal Processor (DSP) 36, a voice/sound processor 38, a display 50, a operation section 51, and a timer 52.

The controller 30 is an example control means for executing a program stored in the storage 34 and the like, and controlling various functional sections. As the controller 30, a Central Processing Unit (CPU) may be used.

The radio section 32 is an example communication means for performing the VoIP communications using the wireless LAN described above under the control of the controller 30. The radio section 32 includes (is connected to) an antenna 53.

The storage 34 includes a program storage 54, a data storage 55, and a Random-Access Memory (RAM) 56. The program storage 54 includes a recording medium and stores programs such as an Operating System (OS) and the handover control program.

The data storage 55 is an example storage means for storing data, and stores various data including the handover cause data including the radio quality data such as the RSSI value, the data of a beacon loss, and the RTP jitter data, and the like. The RAM 56 may be used as the working area.

The DSP 36 is an example of a digital signal processor controlled by the controller 30, and executes various processes including reproducing a voice/sound signal based on the packet data received by the VoIP communications, various signal processing, and processing of the jitter (RTP jitter).

The voice/sound processor 38 is an example of a voice/sound signal processor controlled by the controller 30, and includes a receiver 57 and a microphone 58. The voice/sound processor 38 outputs a voice/sound output from the receiver 57, and receives the voice/sound via the microphone 58 as a voice/sound signal.

The display 50 is an example display means controlled by the controller 30, and may include a Liquid Crystal Display (LCD) device to display character information and image information.

The operation section 51 is an example of an operation input means controlled by the controller 30 and for inputting information input by operations. For example, the operation section 51 may include a keyboard, a mouse, and the like

The timer 52 is an example of a time measurement means for measuring time for setting a predetermined time period used in monitoring the frequency times of the jitters in the RTP packet data.

Next, the radio section 32 is described in detail with reference to FIG. 8. As illustrated in FIG. 8, the radio section 32 includes a handover generator 60 and a handover controller 62. The handover generator 60 corresponds to the handover cause generator 18 described above (FIG. 3).

The handover controller 62 is an example of a control means for instructing the handover based on the handover cause and executing the handover.

As illustrated in FIG. 8, the handover generator 60 includes an RSSI monitor 64, a retransmission monitor 66, an SNR measurement section 68, a Bit Error Rate (BER) measurement section 70, a Packet Error Rate (PER) measurement section 72, a Beacon Loss (BL) measurement section 74, an RTP jitter measurement section 76, and a radio wave measurement section 78.

The RSSI monitor 64 monitors the strength of the radio wave (i.e., the RSSI value) measured by the radio wave measurement section 78. Namely, the RSSI monitor 64 monitors the degradation of the RSSI value, and generates the monitor output. The RSSI monitor 64 reports (inputs) the monitor output to the handover controller 62.

The retransmission monitor 66 monitors the retransmission of the RTP transmission and acquires the retransmission rate. Then, the retransmission monitor 66 reports the retransmission rate to the handover controller 62.

The SNR measurement section 68 measures the Signal-to-Noise Ratio (SNR) of the received radio wave, and reports the SNR to the handover controller 62.

The BER measurement section 70 measures the Bit Error Rate (BER), and reports the measured BER value to the handover controller 62.

The PER measurement section 72 measures the Packet Error Rate (PER), and reports the measured PER value to the handover controller 62.

The BL measurement section 74 measures the Beacon Loss (BL), and reports the measured BL value to the handover controller 62.

The RTP jitter measurement section 76 in an example of the jitter monitor (RTP jitter monitor) 10 described above to measure the jitter of the RTP packet data. The RTP jitter measurement section 76 reports the measurement result of the jitter to the handover controller 62.

The radio section 32 including the various functional sections described above is controlled by the controller 30. On the other hand, as illustrated in FIG. 8, the controller 30 includes a media controller 79. The media controller 79 is a means for controlling the writing and reading the jitter data to and from a jitter buffer 80.

In this case, the jitter refers to the RTP jitter (i.e., jitters of the RTP packet data). Therefore, the jitter buffer 80 stores the jitter (value) corresponding to the RTP jitter. The jitter buffer 80 is set (provided) in the data storage 55 described above (FIG. 7).

Next, an example exterior configuration of the cellular phone devices (HS) 201, 202, 203, . . . , and 20N is described with reference to FIG. 9. As illustrated in FIG. 9, the cellular phone devices (HS) 201, 202, 203, . . . , and 20N include an operation side chassis 82 as a first chassis, a display side chassis 84 as a second chassis, and a hinge 86, the operation side chassis 82 being openably connected to the display side chassis 84 via the hinge 86.

The operation side chassis 82 includes the operation section 51 and the microphone 58. The display side chassis 84 includes the display 50 and the receiver 57. Further, a speaker (not shown) may also be provided as a voice/sound output means.

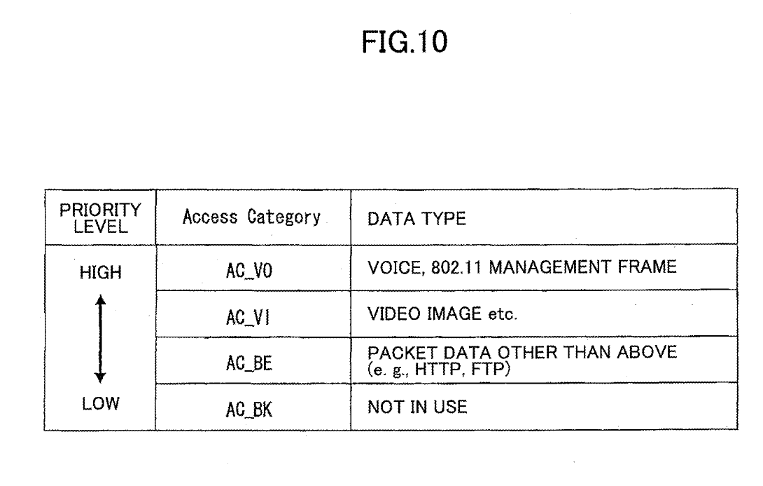

Next, priority levels depending on the types of the transmission packet data are described with reference to FIG. 10. FIG. 10 illustrates an example of the priority levels depending on access categories (i.e., the types of the transmission packet data).

As illustrated in FIG. 10, the symbols “AC_VO”, “AC_VI”, “AC_BE”, and “AC_BK” denote the access categories which correspond to the types of packet data. Namely, various types of the packet data are categorized into the corresponding access categories.

Specifically, the “AC_VO” corresponds to voice/sound data and IEEE 802.11 management frame (fast wireless LAN) data. The “AC_VI” corresponds to a video image data. The“AC_BE” corresponds to the packet data (e.g., HTTP, FTP data) other than the above voice/sound, the management frame, and the video image data. No data is currently assigned to the “AC_BK”.

As illustrated in FIG. 10, the priority levels decrease in the other of “AC_VO”, “AC_VI”, “AC_BE”, and “AC_BK”. Therefore, the packet data corresponding to the “AC_VO” has the highest priority level, and the packet data corresponding to the “AC_BK” has the lowest priority level.

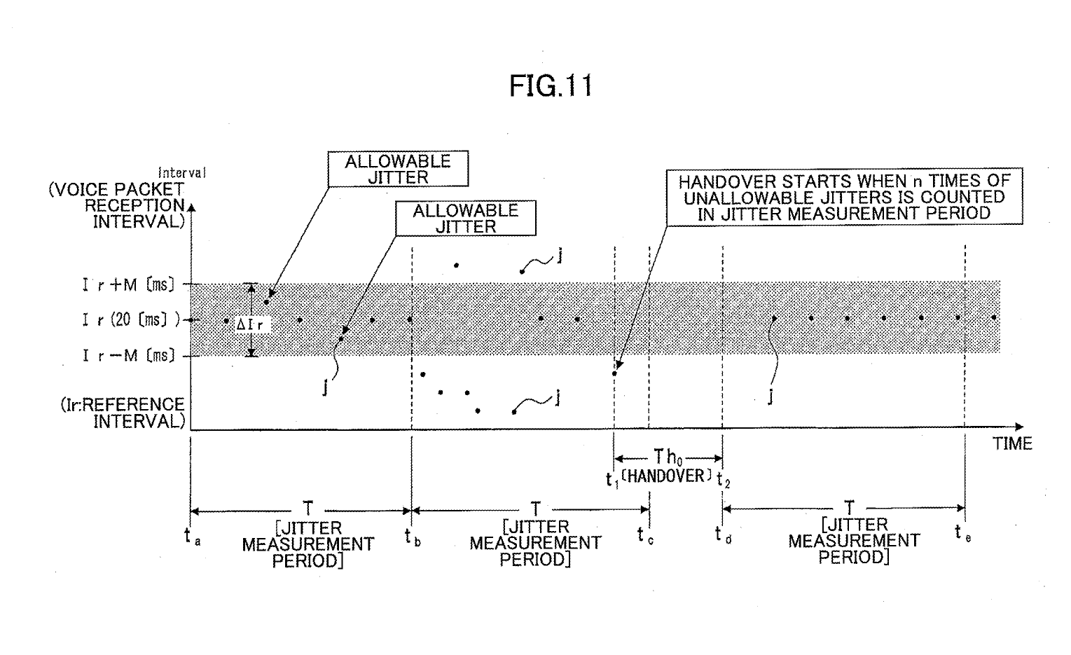

Next, the measurement of the jitters of the RTP packet data is described with reference to FIG. 11. FIG. 11 is an example graph (relational graph) illustrating a relationship between the jitter measurement of the RTP packet data and the handover control.

In the relational graph, the vertical axis denotes the time interval period between consecutively received RTP data packets. Here, a referential interval is defined as “Ir (ms)” (=20 ms), and the upper and the lower limit values are defined as “Ir+M (ms)” and “Ir−M (ms)”, respectively.

Therefore, when the allowable width (range) is defined as “Δir”, the “Δir” is expressed as ΔIr=Ir±M (ms). Namely, the width “ΔIr” denotes the allowable jitter width range from “Ir−M (ms)” to “Ir+M (ms)” and with the reference interval “Ir (ms)”.

On the other hand, the horizontal axis denotes the time, and the symbol “T” denotes a jitter measurement time period which is set as a constant value. Specifically, in FIG. 11, the first jitter measurement time period starts at the timing tₐ and ends at the timing t_{b}.

Also, the next (the second) jitter measurement time period starts at the timing t_{b} and ends at the timing t_{c}. The points “j” denote the measured jitter values at the corresponding timings in the horizontal axis.

In the jitter measurement, when the measured jitter “j” is within the allowable width (range) “ΔIr”, the measured jitter is determined as allowable. However, when the measured jitter “j” is not included within the allowable width (range) “ΔIr”, the measured jitter is determined as not allowable jitter.

Referring to FIG. 11, in the first jitter measurement time period (from timing tₐ to timing t_{b}), all the measured jitters “j” are within the allowable width (range) “ΔIr”. However, in the next (the second) jitter measurement time period (from timing t_{b} to timing t_{c}), there are many measured jitters “j” outside the allowable width (range) “ΔIr”, and the rate of the measured jitters “j” outside the allowable width (range) “ΔIr” to the measured jitters “j” with the allowable width (range) “ΔIr” is high.

Here, the handover is determined to be executed when the number (frequency number) of the occurrences of the outside measured jitters within the same jitter measurement time period exceeds a predetermined reference value (n).

In this case of FIG. 11, the condition of generating the handover cause is satisfied in the (second) jitter measurement time period T, and the handover starts at the timing t₁ and ends at the timing t₂. Namely, the time period “Th₀” starting from the timing t₁ and ending at the timing t₂ denotes the execution period of the handover.

At the timing t_{d} when the handover is completed, another jitter measurement time period T starts and runs until the timing tₑ, and the jitter is measured repeatedly. In this jitter measurement time period T (from timing t_{d} to timing tₑ), the measured jitter values are substantially constant, and the communications are stable.

In this case, whether the handover is to be executed may be determined based on the logical “AND” condition. Namely, whether the handover is to be executed may be determined when 1) the handover cause due to a reference of another radio quality indicator is generated and 2) the handover cause due to the excessive frequency times of the measured jitter exceeding the predetermined reference value is also generated.

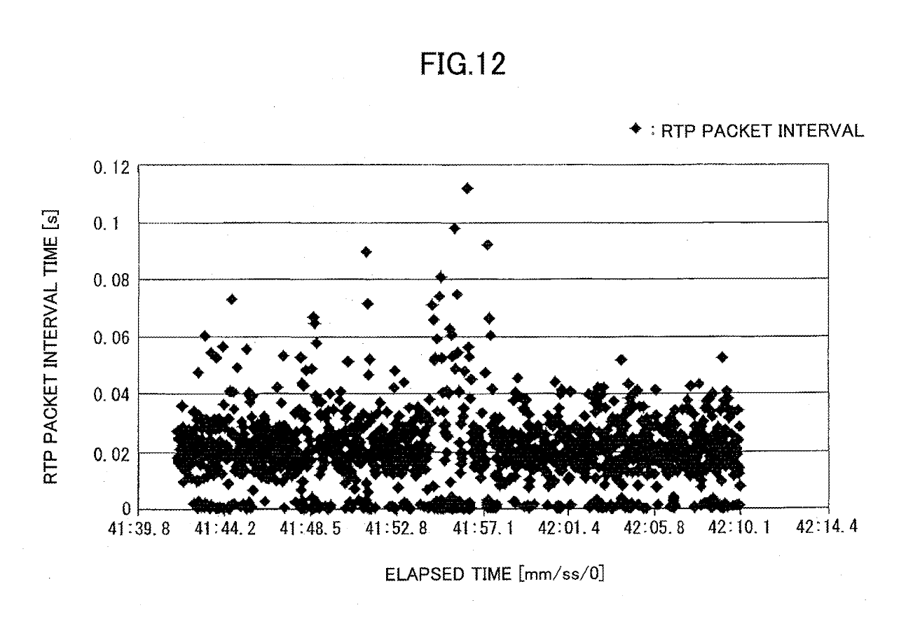

Next, the change of a RTP packet interval when the workload is increased is described with reference to FIG. 12. FIG. 12 illustrates the change of the RTP packet interval when the workload is increased.

The change of the RTP packet interval when the workload is increased of FIG. 12 is a simulation result illustrating that the voice/sound quality is influenced (degraded) when the workload is increased. In FIG. 12, the horizontal axis denotes the elapsed time, and the vertical axis denotes the RTP packet interval time, the rectangular dots denote the data of the RTP packet intervals P and the frequency times of the jitters of the RTP packet data.

According to this simulation result, when the workload is increased, the large jitters which are largely different from the reference RTP packet interval time (i.e., 20 ms) are observed. Here, it is assumed that the RTP packet data are transmitted and reproduced every 20 ms.

However, when the workload in the frequency band increases, the jitter of the RTP packet interval P is generated. The degradation of the voice/sound quality due to the depletion of the memory capacity of the jitter butter may be generated due to the accumulation of the delays of the RTP packet data.

However, such degradation of the voice/sound quality may also be generated when the RTP packet data are transmitted from the AP at a shorter RTP packet interval. In any case, the increase of the workload in the frequency band may cause the jitters of the RTP packet data and degrade the voice/sound quality.

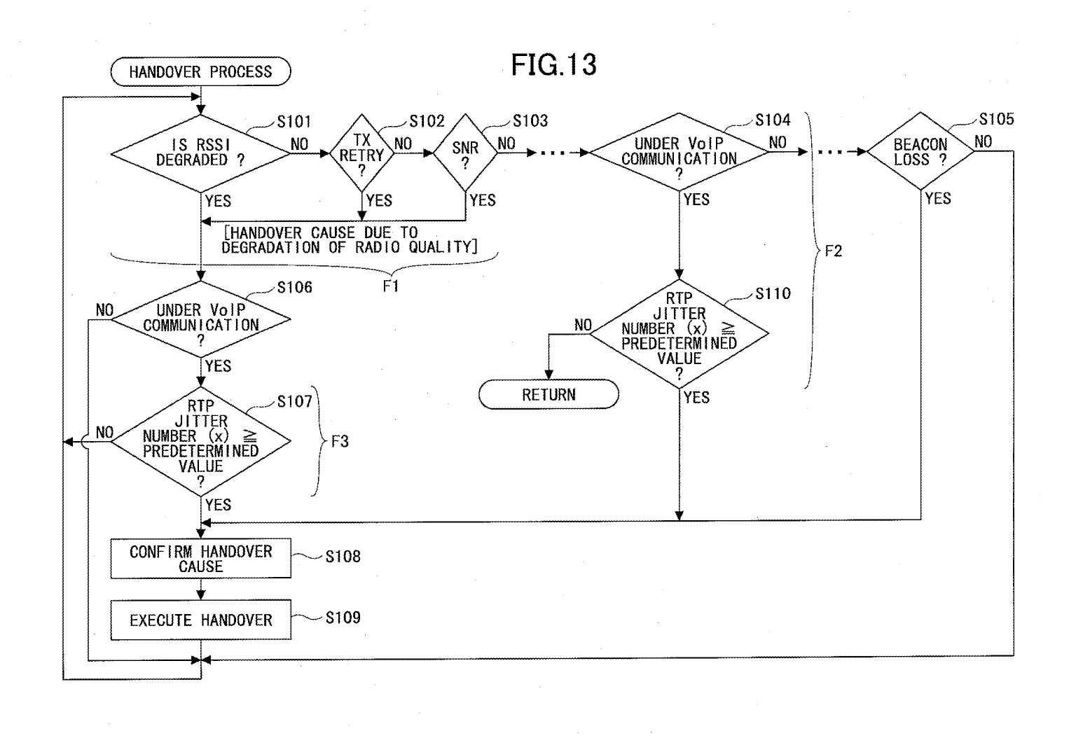

Next, the handover control is described with reference to FIG. 13. FIG. 13 is an example flowchart of a handover control process. The flowchart of FIG. 13 is an example only, and the present invention is not limited to the flowchart.

The handover process is an example of the handover control method according to an embodiment. Namely, the handover process is an example of a main routine of the handover according to an embodiment, and based on the considerations of the handover cause due to the degradation of the radio wave and the handover cause due to the frequency times (numbers) of the RTP jitters.

The process of FIG. 13 includes a monitoring process (F1) monitoring the handover cause due to the degradation of the radio wave and a monitoring process (F2 and F3) monitoring the jitter of the RTP packet data. In this embodiment, the logical “AND” condition is used to confirm the handover cause.

The monitoring process F1 includes a step of monitoring the RSSI value (step S101), a step of monitoring the Tx Retry (retransmission) (step S102), and a step of monitoring the SNR (step S103). Specifically, in the step of monitoring the RSSI value (step S101), it is determined whether the change of the RSSI value reaches (corresponds to) a level where the handover is to be executed.

In the step of monitoring the Tx Retry (retransmission) (step S102), it is determined whether the number of the retransmissions reaches (corresponds to) the number where the handover is to be executed. Further, in the step of monitoring the SNR (step S103), it is determined whether the SNR (Signal to Noise Ratio) level reaches (corresponds to) the level where the handover is to be executed.

In this embodiment, first, it is determined whether there is a problem in the monitored RSSI value (i.e. the monitored RSSI value exceeds a predetermined value (level)) (step S101). When determining that there is no problem in the measured the RSSI value (NO in step S101), it is further determined whether the number of the retransmission reaches the number where the handover is to be executed (in step S102).

When determining that the number of the retransmissions does not reach the number where the handover is to be executed (NO in step S102), it is further determined whether the SNR level reaches the level where the handover is to be executed (in step S103).

When determining that the SNR level does not reach the level where the handover is to be executed (NO in step S103), it is further determined whether the VoIP communication is being conducted (step S104). When determining that the VoIP communication is not being conducted (NO in step S104), it is determined whether the Beacon Loss is generated (step S105).

When determining that the RSSI value is less than or equal to the predetermined level (YES in step S101), when determining that the number of the retransmissions reaches the number where the handover is to be executed (YES in step S102), or when determining that the SNR level reaches the level where the handover is to be executed (YES in step S103), the handover cause due to the degradation of the radio wave is generated.

When the handover cause is generated, it is further determined whether the VoIP communication is being conducted (step S106). When determining that the VoIP communication is not being conducted (NO in step S106), the process ends.

On the other hand, when determining that the VoIP communication is being conducted (YES in step S106), it is further determined whether the RTP jitter number (x) exceeds a predetermined (reference) value, the RTP jitter number (x) indicating the frequency times (numbers) of the jitters exceeding the allowable value of the RTP packet data (step S107).

In this case, even when the handover cause due to (based on) the degradation of the radio wave is generated, if the RTP jitter number (x) is less than the predetermined value (NO in step S107), the process does not go to steps S108 and S109. On the other hand, when determining that the RTP jitter number (x) exceeds a predetermined (reference) value (YES in step S107), the handover cause is confirmed (step S108), and the handover is executed (step S109). Namely, the connecting AP is changed (switched) from the currently connecting AP to another AP.

Further, in step S104, when determining that the VoIP communication is being conducted (YES in step S104), it is determined whether the RTP jitter number (x) is greater than or equal to the predetermined value (step S110). When determining that the RTP jitter number (x) is less than the predetermined value (NO in step S110), the process goes back to step S101 to repeat the same process.

When determining that the RTP jitter number (x) is greater than or equal to the predetermined value (YES in step S110), the handover cause based only on the RTP jitter is confirmed (in step S108), and the handover is executed (in step S109).

Namely, under the condition that the VoIP communication is being conducted (YES in step S104), even when the degradation of the radio wave is not detected, as long as the RTP jitter number (x) is greater than or equal to the predetermined value (YES in step S110), the handover is executed.

Further, when it is determined that the Beacon Loss is generated (step S105), the Beacon Loss is thought to be one of the handover causes. Therefore, the process goes to steps S108 and S109 to confirm the handover cause (step S108), and the handover is executed (step S109).

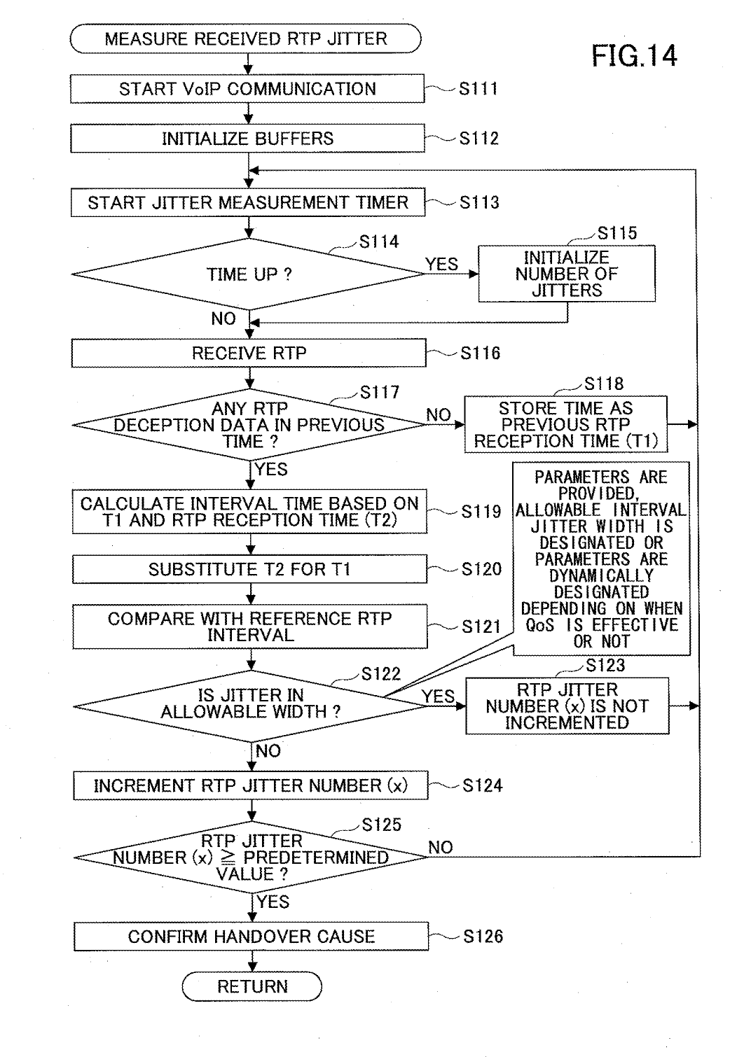

Next, the measurement of the jitter of the received RTP packet data is described with reference to FIG. 14. FIG. 14 is an example flowchart of a process of measuring the jitter of the received RTP packet data.

The process of FIG. 14 corresponds to the steps S107 and S110 of FIG. 13. In the process of FIG. 14, when the VoIP communication is started (step S111), the data in buffers are initialized (step S112), and a jitter measurement timer is started (step S113).

Then, the jitter measurement timer is monitored and it is determined that the jitter measurement timer is timed up (step S114). When determining that the jitter measurement timer is timed up (YES in step S114), the number of jitters is initialized (step S115). When determining that the jitter measurement timer is not timed up (NO in step S114), the RTP (i.e., voice/sound packet data) are received (step S116). Then, it is determined whether there is a receiving record of receiving the last RTP (step S117).

When determining that there is no receiving record (NO in step S117), the last RTP receiving time is set as “T1” and the “T1” is recorded (step S118). Then, the process goes back to step S113.

When determining that there is a receiving record of receiving the last RTP (YES in step S114 in step S117), the interval time is calculated based on the last RTP receiving time T1 and the latest RTP receiving time T2. In this case, the time T2 is substituted into the time T1 (step S120), and the calculated interval time is compared with the reference RTP interval which is the reference value (step S121).

Then, based on the comparison in step S121, it is determined whether the interval time is (corresponds to the jitter) within the allowable width (range) (step S122). In this determination, as a parameter, the allowable width (range) of the jitter is designated, and further, as the allowable width (range) of the jitters, different parameters are dynamically designated depending on whether the QoS is effective or not (ineffective).

When determining that the interval time is within the allowable width (range) (YES in step S122), the value of the number of jitters is not incremented (step S123), and the process goes back to step S113. When determining that the interval time is not within the allowable width (range) (NO in step S122), the value of the number of jitters is incremented (step S124).

Then, it is determined whether the RTP jitter number (x) is greater than or equal to the predetermined value (step S125). When determining that the RTP jitter number (x) is less than the predetermined value (NO in step S125), the process goes back to step S113.

When determining that the RTP jitter number (x) is greater than or equal to the predetermined value (YES step S125), the handover cause is generated (step S126), and the process goes back to step S111 to repeat a similar process.

Based on the generation of the handover cause (in step S126), the process goes back to the main routine (FIG. 13). By doing this, the handover is executed, that is, the connection is changed (switched) from the currently connecting AP to an AP having greater strength of an electric field.

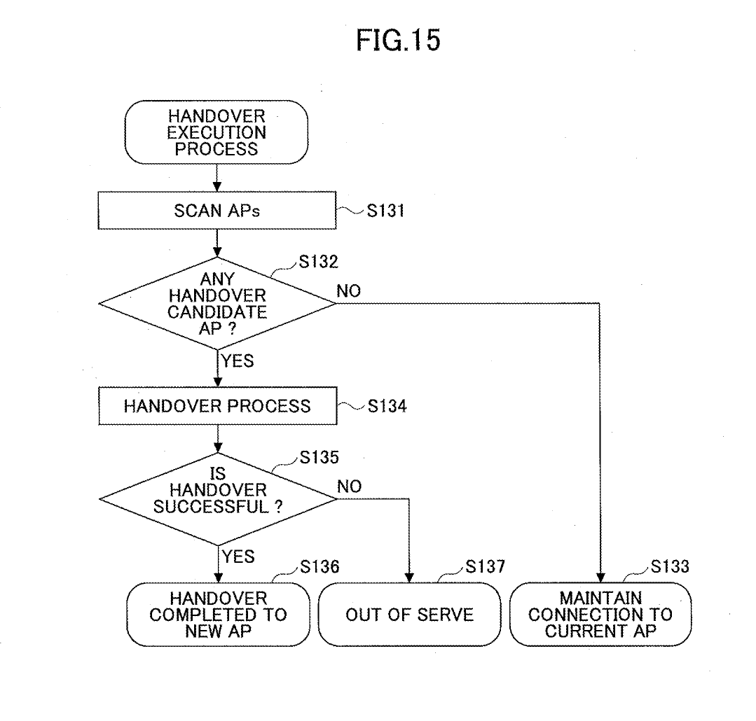

Next, the handover execution process is described with reference to FIG. 15. FIG. 15 is an example flowchart of the handover execution process. The flowchart of FIG. 15 is an example only, and the present invention is not limited to the flowchart.

This process corresponds to the process in step S109 of FIG. 13. In this process, as illustrated in FIG. 15, when the handover process starts, scanning is performed on the APs (step S131), and it is determined whether there exists an AP as a handover candidate (the AP is searched for) (step S132).

When determining that there exists no AP as the handover candidate (NO in step S132), the connection to the currently connecting AP is maintained, that is, the communication terminal device (cellular phone device) continues to belong to the currently connecting AP and no handover is executed (step S133).

When determining that there exists the AP as the handover candidate (YES in step S132), the handover process is executed so as to change the connection from the currently connecting AP to the (searched-for) AP as the handover candidate (step S134).

Then, it is determined whether the handover is successful (step S135). When determining that the handover is successful (YES in step S135), the connection to the new AP (the AP searched for as the handover candidate) is maintained, so that the handover is completed (step S136).

When determining that the handover has failed (NO in step S135), the communication terminal device (cellular phone device) is out of service due to the connection failure (step S137). Namely, no connection is established.

This third embodiment may have the following features and advantages.

(1) Even when the radio quality is not degraded, if the RTP jitter number (x) is greater than or equal to a predetermined value, the handover cause is confirmed. That is, when determining the execution of the handover, a higher priority is given to the RTP jitter number (x) (process F2).

(2) Even when the handover cause is generated due to the degradation of the radio quality, if the RTP jitter number (x) is less than the predetermined value, the handover cause is not confirmed. That is, to confirm the handover cause, it is necessary that the RTP jitter number (x) is greater than or equal to the predetermined value (process F3).

(3) In the above embodiment, when the RTP packet data categorized as the AC3 (AC_VO) is received in a constant time period, the jitter of the RTP packet data is measured, and the handover cause is generated. When VoIP communication starts, all the parameters are initialized and the jitter measurement timer (i.e., the timer 52) is started. The jitter measurement timer is timed up based on an arbitrary timer value. In the time period corresponding to the timer value, the number of jitters that are not within an allowable range (i.e., the RTP jitter number (x)) is counted (measured). When the measured RTP jitter number (x) is greater than or equal to a predetermined value, the handover cause is generated.

(4) In a case where the VoIP communication is being conducted, after the handover cause is generated, when the logical “AND” condition of the degradation of the strength of the radio wave (strength of the electric field; RSSI value) or the like and the RTP jitter number (x) being greater than or equal to a predetermined value (i.e., when determining that the strength of the radio wave is degraded and also the RTP jitter number (x) is greater than or equal to a predetermined value), the handover cause is generated. In the flowcharts of FIGS. 13 and 14, the predetermined value to be compared with the RTP jitter number (x) in steps S107 and S110 of FIG. 13 and in step S125 of FIG. 14 may be the same as each other or different from each other.

(5) It may become possible to avoid the inconvenience that the execution of the handover is determined based on the strength of the radio wave (strength of the electric field; RSSI value) from the AP, that is, if it is a case, even if the voice/sound quality in the voice/sound data communications is degraded, if only the strength of the radio wave (RSSI value) is determined as a good condition, no handover is executed. In other words, in the above embodiment, when the VoIP communication is conducted, without depending on the APs, the cellular phone devices (HS) 201, 202, 203, . . . , and 20N side generate the handover cause, and cause the APs side to execute the handover. Therefore, it may become possible to reduce the communications cut during the call, wasteful handovers generated when the communication terminal device is between the APs, and the degradation of the voice/sound quality due to oppression in the frequency band, and distribute the workload of the APs.

(6) It is not necessary for the AP to have an expensive Call Admission Control (CAC) function (to control to limit the number of voice calls to a constant value), and the handover cause is generated based on the RTP jitter number (x). As a result, the workloads may be distributed. The jitter of the RTP packet data depends on the load condition of the AP. Therefore, when the handover is executed based on the RTP jitter number (x), as a result, it may become possible to reduce or distribute the workloads of the APs. Further, when compared with the voice/sound quality while the handover is frequently repeated, the voice/sound quality may be improved and the degradation of the voice/sound quality may also be prevented.

(7) It may become possible to prevent wasteful repetition of the handover.

(8) It may become possible to prevent the frequently repeated handovers when a communication terminal device is disposed in an area where the strengths of the radio waves (i.e., the RSSI value) from the APs are near the threshold values, the area being between plural APs. Further, it may become possible to improve the voice/sound quality and prevent the degradation of the voice/sound quality. Further, it may become possible to prevent (reduce) the no voice/sound condition caused by unnecessary handovers, and stabilize the voice/sound quality.

(9) It may become possible to reduce a difference between the degradation of the RSSI value determining the out of service and the degradation of the voice/sound quality, and improve the reliability and the quality of the voice/sound data communications.

### Fourth Embodiment

In a fourth embodiment, when the RTP packet data categorized as AC3 (AC-VO) is received, the jitter of the RTP packet data is measured, and a rate of the jitter to the interval of the RTP packet data is detected. Further, the handover cause is generated based on the logical “AND” condition of the degradation of the RSSI value and the jitter.

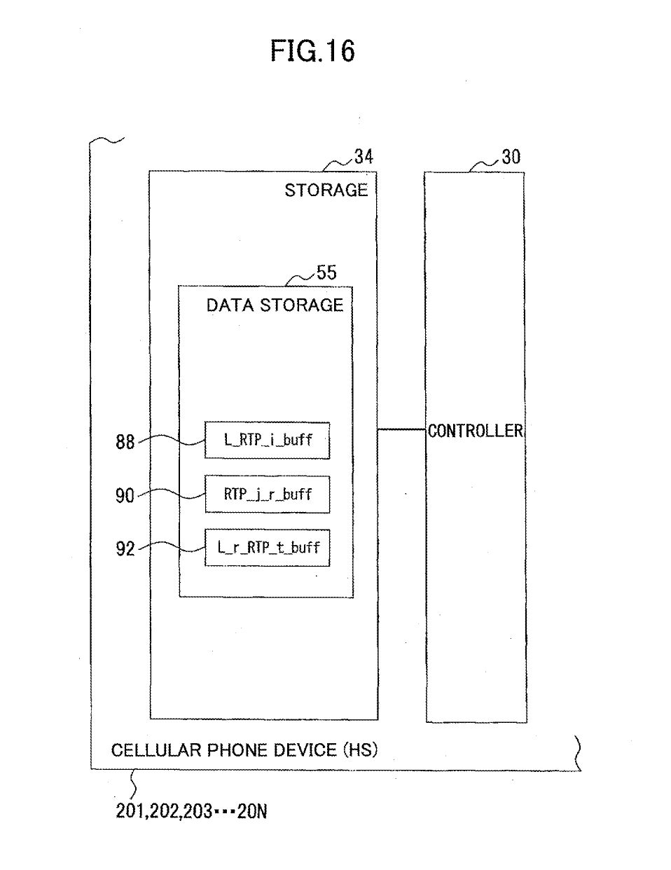

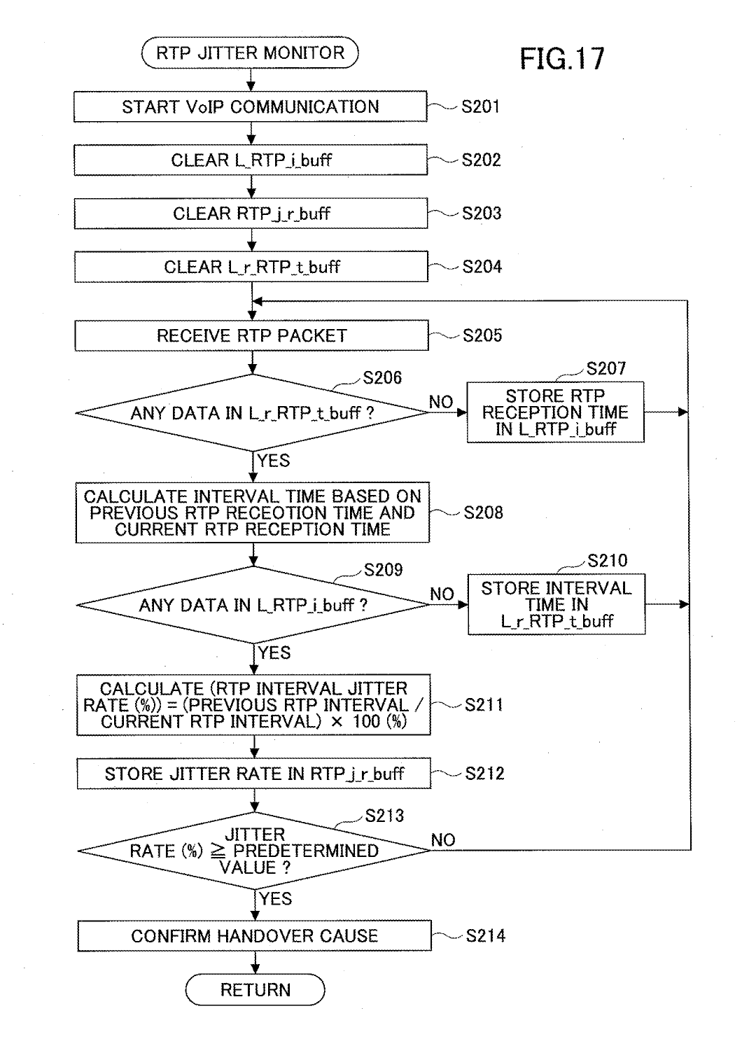

The fourth embodiment is described in detail with reference to FIGS. 16 through 18. FIG. 16 illustrates an example cellular phone device. FIG. 17 is an example flowchart of measuring the jitter.

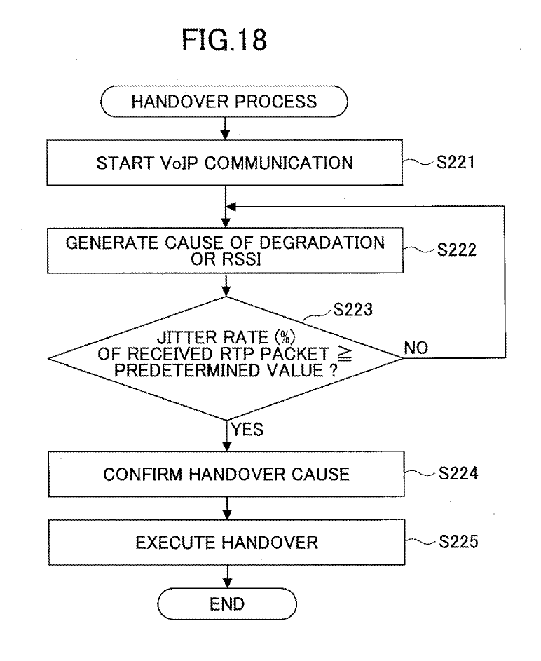

FIG. 18 is an example flowchart of the handover process. The configuration and the flowcharts of FIGS. 16 through 18 are examples only. The present invention is not limited to the configuration and the flowcharts.

In a received RTP jitter measurement system in this embodiment, the data storage 55 of the storage 34 in the cellular phone devices (HS) 201, 202, 203, . . . , and 20N includes a Last RTP interval buffer (L_RTP_i_buff) 88, an RTP jitter rate buffer (RTP_j_r_buff) 90, and a Last received RTP time buffer (L_r_RTP_t_buff) 92.

The Last RTP interval buffer (L_RTP_i_buff) 88 stores the RTP interval in the previous time. The RTP jitter rate buffer (RTP_j_r_buff) 90 stores an RTP interval jitter rate (%). Herein, the RTP interval jitter rate (%) is calculated based on the formula: (an RTP interval in the previous time/an RTP interval in this time)×100(%). The Last received RTP time buffer (L_r_RTP_t_buff) 92 stores an RTP receiving time in the previous time. Elements other than the above are similar to those in the third embodiment.

In the process of measuring the jitter of the received RTP packet data, as illustrated in FIG. 17, when the VoIP communication is started (step S201), the data in the Last RTP interval buffer (L_RTP_i_buff) 88, the RTP jitter rate buffer (RTP_j_r_buff) 90, and the Last received RTP time buffer (L_r_RTP_t_buff) 92 are initialized (steps S202, S203, and S204, respectively). Therefore, stored data are intialized.

When the RTP packet data are received (step S205), it is determined whether there are data in the Last received RTP time buffer (L_r_RTP_t_buff) 92 (step S206). When determining that there are no data in the Last received RTP time buffer (L_r_RTP_t_buff) 92 (NO in step S206), the RTP receiving time is stored in the Last RTP interval buffer (L_RTP_i_buff) 88 (step S207).

When determining that there are data in the Last received RTP time buffer (L_r_RTP_t_buff) 92 (YES in step S206), the time interval is calculated based on the RTP receiving time in the previous time and the RTP receiving time in this time (step S208).

Next, it is determined whether there are data in the Last RTP interval buffer (L_RTP_i_buff) 88 (step S209). When determining that there are no data in the Last RTP interval buffer (L_RTP_i_buff) 88 (NO in step S209), the interval time is stored in the Last received RTP time buffer (L_r_RTP_t_buff) 92 (step S210).

When determining that there are data in the Last RTP interval buffer (L_RTP_i_buff) 88 (YES in step S209), the RTP interval jitter rate (%) (i.e., (the RTP interval in the previous time/the RTP interval in this time)×100(%)) is calculated (step S211) and stored in the RTP jitter rate buffer (RTP_j_r_buff) 90 (step S212).

Next, as the determination whether the jitter is greater than or equal to the allowable value, it is determined whether the calculated RTP interval jitter rate (%) is greater than or equal to a predetermined value (step S213).

When determining that the calculated RTP interval jitter rate (%) is less than the predetermined value (NO in step S213), the process goes back to step S205. When determining that the calculated RTP interval jitter rate (%) is greater than or equal to a predetermined value (YES in step S213), the handover cause is generated (step S214), an the process goes back to step S201.

By executing the process described above, it may become possible to easily and accurately measure whether a jitter rate greater than or equal to the allowable value is generated in the RTP packet data, and generate the handover cause.

In the handover process using such a handover cause, as illustrated in FIG. 18, when the VoIP communication is started (step S221), the handover cause due to the degradation of the RSSI value is generated (step S222).

Then, it is determined whether a jitter rate of the received RTP packet data is greater than or equal to a predetermined value (step S223). The determination whether the jitter rate of the received RTP packet data is greater than or equal to the predetermined value is the same as that described with reference to FIG. 17.

Then, the handover cause is generated based on the handover cause due to the degradation of the RSSI value and the handover cause when the jitter rate of the received RTP packet data is greater than or equal to the predetermined value (step S224). Based on the handover cause, the handover is executed (step S255), and the handover ends.

The features and the advantages in the fourth embodiment are described below.

(1) In this embodiment, the jitter of the RTP packet data categorized as AC3 (AC_VO) is measured, and based on the interval of the RTP packet data, the generation of a jitter having an arbitrary rate is measured, and the handover cause is generated.

(2) The handover cause is generated based on the logical “AND” condition of the handover cause due to the degradation of the RSSI value and the handover cause due to the RTP packet data jitter having an arbitrary rate.

(3) Other features and advantages are the same as those in the third embodiment.

### Fifth Embodiment

In a fifth embodiment, similar to the fourth embodiment, the jitter rate of the RTP packet data is measured. Then, based on the logical “AND” condition of the jitter rate of the RTP packet data, the degradation of the RSSI value, and the retransmission rate of the transmission RTP, the handover cause is generated.

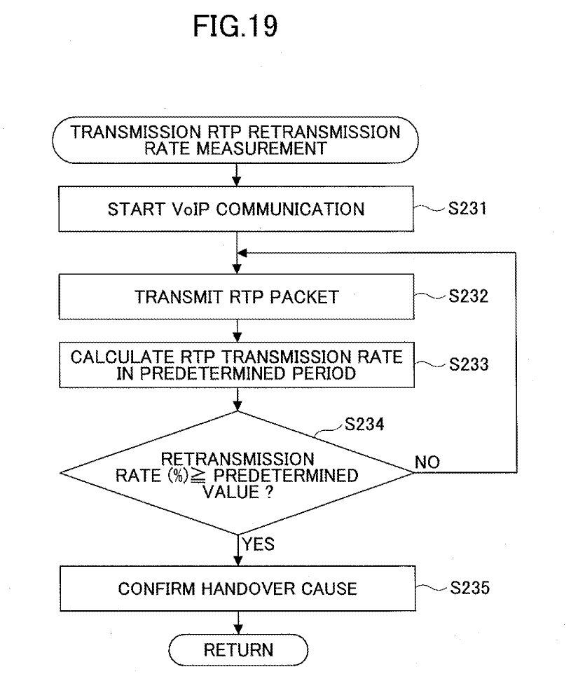

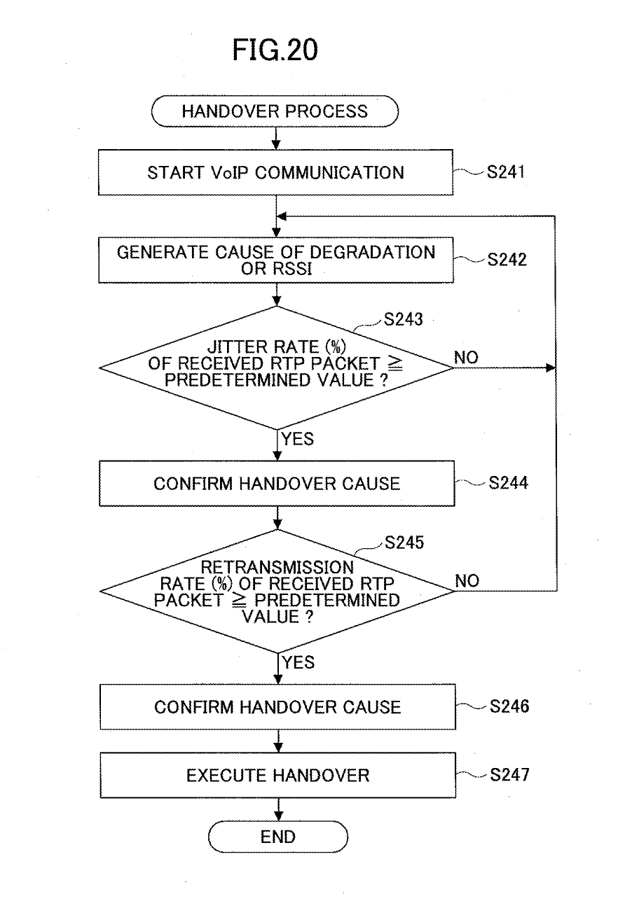

The fifth embodiment is described with reference to FIGS. 19 and 20. FIG. 19 is an example flowchart of measuring a transmission RTP retransmission rate. FIG. 20 is an example flowchart of the handover process. The flowcharts in FIGS. 19 and 20 are examples only, and the present invention is not limited to the flowcharts.

In this embodiment, the process of measuring the jitter of the received RTP packet data (FIG. 17) is used. The buffer configuration in the data storage 55 is similar to that in the fourth embodiment. Except for the above, the configuration in this embodiment is similar to that in the third embodiment.

In the process of measuring the transmission RTP retransmission rate, as illustrated in FIG. 19, when the VoIP communication is started (step S231), the RTP packet data are transmitted (step S232). Based on the transmission of the RTP packet data, an RTP retransmission rate in a constant time period is calculated (step S233). Then, it is determined whether the retransmission rate is greater than or equal to a predetermined value (step S234).

When determining that the retransmission rate is less than the predetermined value (NO in step S234), the process goes back to step S232 and the same process is performed. When determining that the retransmission rate is greater than or equal to the predetermined value (YES in step S234), the handover cause is generated (step S235).

In the handover process where the handover causes due to the degradation of the RSSI value and the RTP retransmission rate are added, as illustrated in FIG. 20, when the VoIP communication is started (step S241), the handover cause due to the degradation of the RSSI value is generated (step S242). Then, it is determined whether the jitter rate of the RTP packet data is greater than or equal to a predetermined value (step S243).

When determining that the jitter rate of the RTP packet data is greater than or equal to a predetermined value (YES in step S243), the handover cause is generated (step S244). The determination whether the jitter rate of the RTP packet data is greater than or equal to a predetermined value is described in the process described with reference to FIG. 17.

Then, it is determined whether the retransmission rate of the received RTP packet data is greater than or equal to a predetermined value (step S245). When determining that the retransmission rate of the received RTP packet data is greater than or equal to a predetermined value (YES in step S245), the handover cause is generated (step S246). Then, the based on the handover cause, the handover is executed (step S247), and the process is terminated.

The features and the advantages of the fifth embodiment are described below.

(1) In this embodiment as well, by measuring the jitter of the RTP packet data categorized as AC3 (AC_VO) and detecting the generation of the jitter having an arbitrary rate of the RTP packet rate in the interval, the handover cause is generated.

(2) By detecting the generation of an arbitrary retransmission rate of the RTP packet data in an arbitrary time period, the handover cause is generated.

(3) The handover is executed based on the logical “AND” condition of the handover cause due to the degradation of the RSSI value, the handover cause due to the jitter of the RTP packet data, and the handover cause due to the transmission rate of the RTP packet data.

In the fifth embodiment, when determining that the jitter rate of the RTP packet data is greater than or equal to the predetermined value (YES in step S243), the handover cause is generated (step S244) and the process goes to step S245. However, the present invention is not limited to this flowchart. Namely, for example, when determining that the jitter rate of the RTP packet data is greater than or equal to the predetermined value (YES in step S243), the process may go to step S245 without generating the handover cause. Further, when determining that the retransmission rate of the received RTP packet data is greater than or equal to the predetermined value (YES in step S245), the handover cause may be generated based on the logical “AND” condition of the both positive determination results.

### Other Embodiments

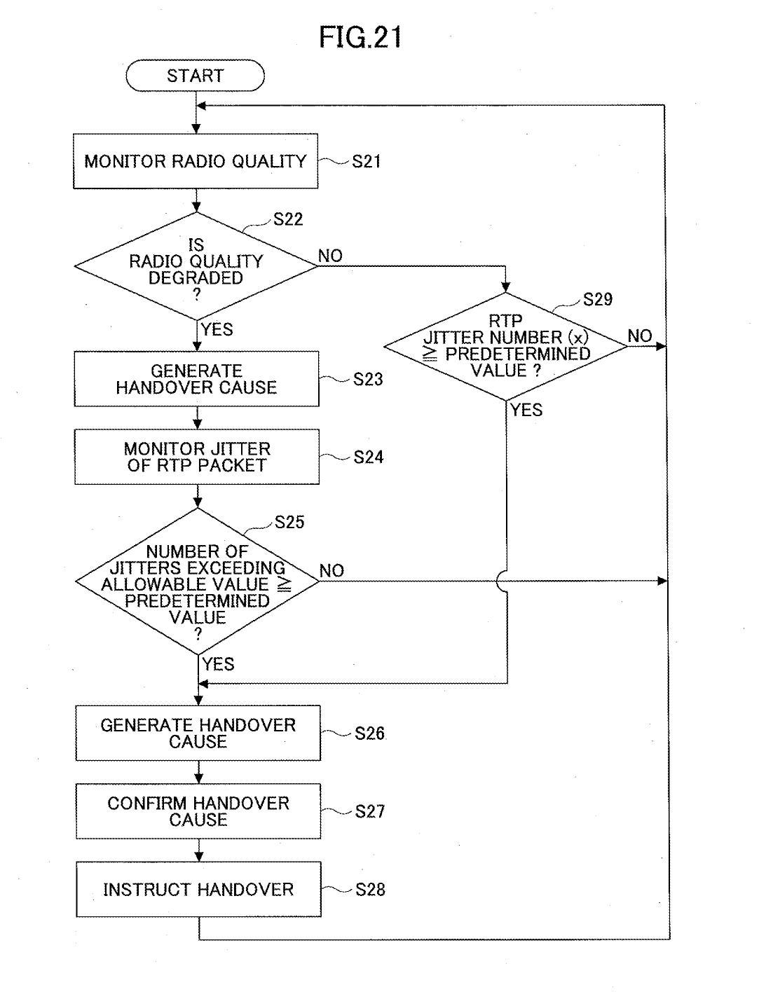

(1) In the second embodiment, as illustrated in FIG. 21, when the radio quality is not degraded (NO in step S22), similar to step S25, it may be determined whether the frequency times (the number of times) of the jitters exceeding an allowable value is greater than or equal to a predetermined value (step S29).

Namely, in a case where the handover is executed by monitoring the radio quality such as the degradation of the RSSI value, when the radio quality is good (NO in step S22), it may be determined whether the frequency times of the jitters exceeding the allowable value is greater than or equal to the predetermined value (step S29). When determining that the frequency times of the jitters exceeding the allowable value is greater than or equal to the predetermined value (YES in step S29), the handover cause is generated (step S26).

When determining that the frequency times of the jitters exceeding the allowable value is less than the predetermined value (NO in step S29), the process goes back to step S21. According to the flowchart, it may become possible to avoid the inconvenience that the handover is not executed even when the voice/sound quality is degraded.

Further, in a case where the radio quality is used as a reference, it may become possible to reduce the degradation of the voice/sound quality due to the repetition of the handover when the communication terminal device is disposed between APs and the strengths of the radio waves from the APs are near the threshold values.

(2) In the third embodiment, the radio section 32 includes the handover generator 60. Further, the handover generator 60 includes, for example, the RSSI monitor 64 and the RTP jitter measurement section 76 (FIG. 8).

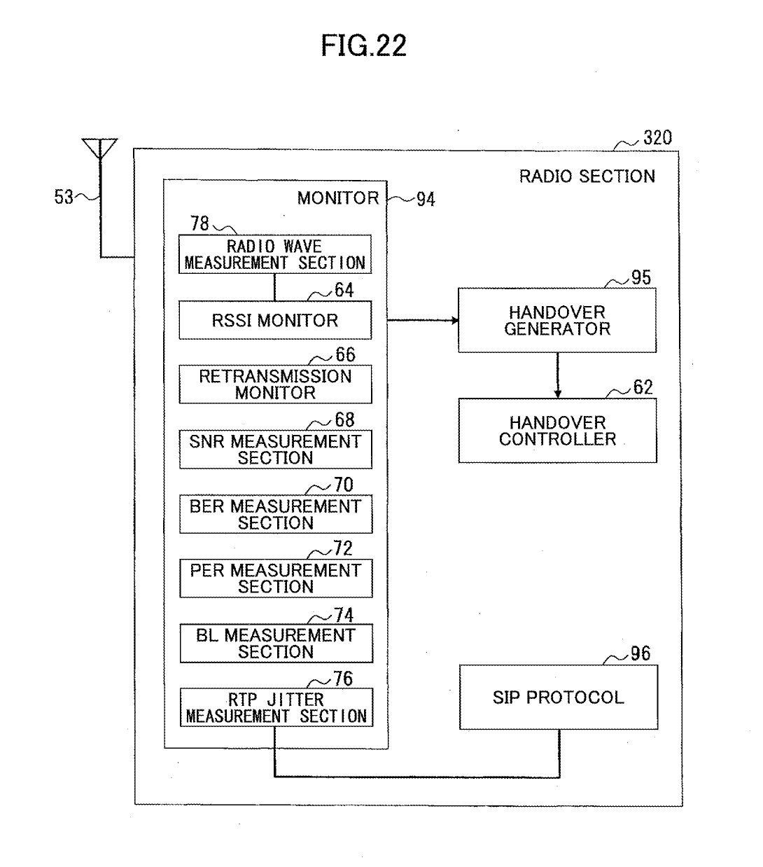

However, the present invention is not limited to this configuration. For example, as illustrated in FIG. 22, a radio section 320 may include a monitor 94 and a handover generator 95, and the monitor 94 may include the RSSI monitor 64 and the RTP jitter measurement section 76. In this case, based on the monitoring results, the handover cause may be generated.

In this case, the RTP jitter measurement section 76 receives the SIP protocol 96 and measures the jitter of the RTP packet data.

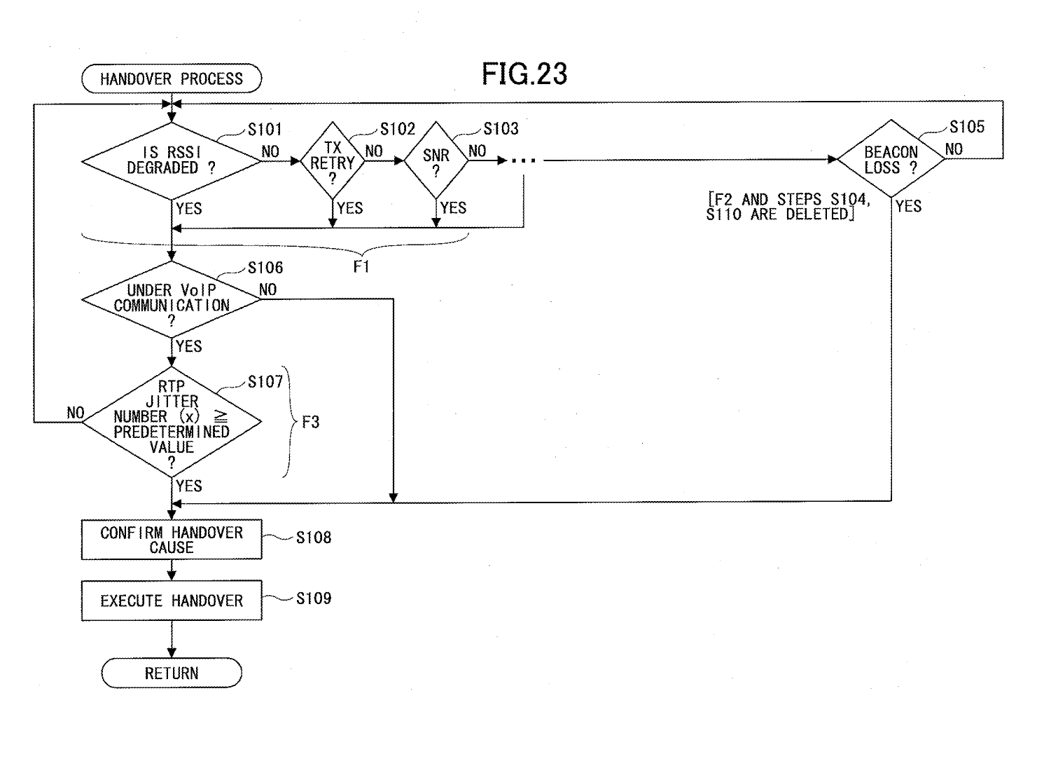

(3) With respect to the handover process, in the third embodiment, the process of monitoring the jitter of the RTP packet data is performed in the process “F2” and the process “F3” (FIG. 13). However, as illustrated in FIG. 23, the process of monitoring the jitter of the RTP packet data (process “F2”) may be deleted so that the process “F2” be omitted.

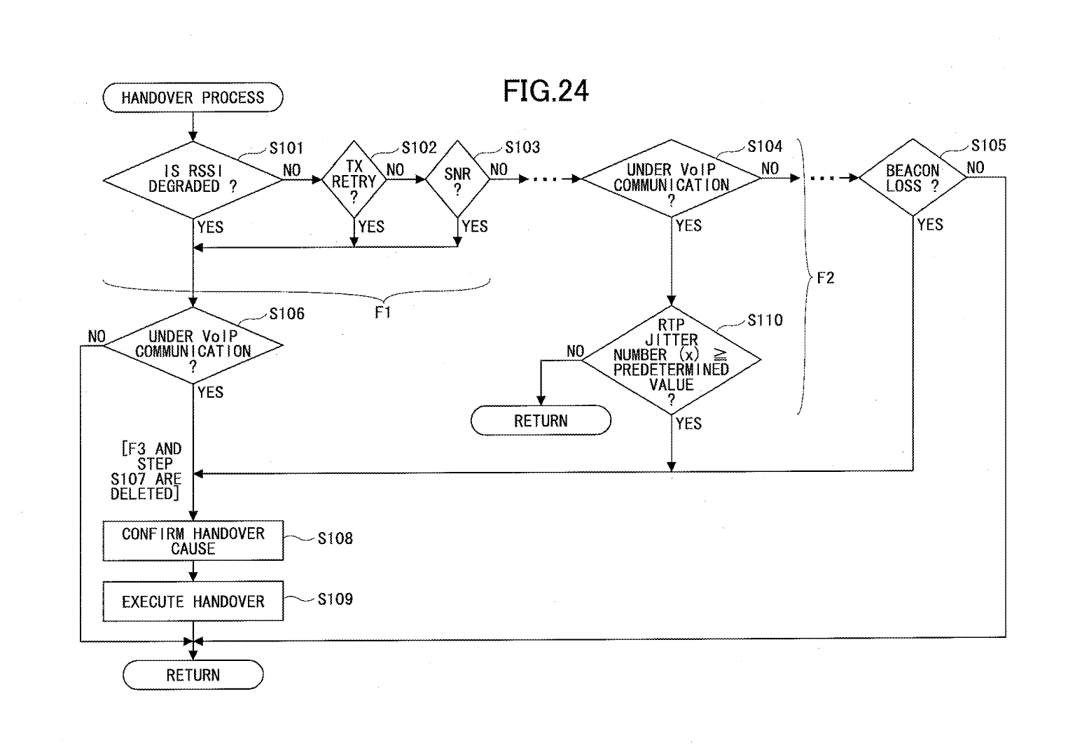

Further, as illustrated in FIG. 24, the process of monitoring the jitter of the RTP packet data (process “F3”) may be deleted so that the process “F2” be omitted. When the process of monitoring the jitter of the RTP packet data (process “F2”) is deleted, the execution of the handover is based on the logical “AND” condition of the handover cause due to the degradation of the radio quality and the handover cause due to the jitter of the RTP packet data.

On the other hand, when the process of monitoring the jitter of the RTP packet data (process “F3”) is deleted, the execution of the handover is based on the logical “OR” condition of the handover cause due to the degradation of the radio quality and the handover cause due to the jitter of the RTP packet data.

(4) With respect to the frequency times of the jitter of the RTP packet data, in the fourth embodiment, the formula: (the RTP interval in the previous time/the RTP interval in this time)×100(%) is used.

Namely, a ratio of the RTP interval in the previous time to the RTP interval in this time is calculated. However, the communication terminal device, the handover control method, and the handover control program in the present application are not limited to this. Namely, for example, any of the following formulas may be used to obtain the RTP interval jitter rate (%).

a) When the RTP interval jitter rate (%) is defined as a rate of the RTP interval in this time to the RTP interval in the previous time, the following formula (1) may be used.

RTP interval jitter rate (%)=(the RTP interval in this time/the RTP interval in the previous time)×100(%) (1)

b) When the RTP interval jitter rate (%) is defined as a rate of the difference between the RTP interval in this time and the RTP interval in the previous time to the RTP interval in this time, the following formula (2) may be used.

RTP interval jitter rate (%)=(the RTP interval in this time)−(the RTP interval in the previous time)/(the RTP interval in this time)×100(%) (2)

c) When the RTP interval jitter rate (%) is defined as a rate of the difference between the RTP interval in this time and the RTP interval in the previous time to the RTP interval in the previous time, the following formula (3) may be used.

RTP interval jitter rate (%)={(the RTP interval in this time)−(the RTP interval in the previous time)}/(the RTP interval in the previous time)×100(%) (3)

(5) In the above embodiment, a case is described where the cellular phone devices (HS) 201, 202, 203, . . . , and 20N are used. However, the communication terminal device, the handover control method, and the handover control program in the present application are not limited to this.

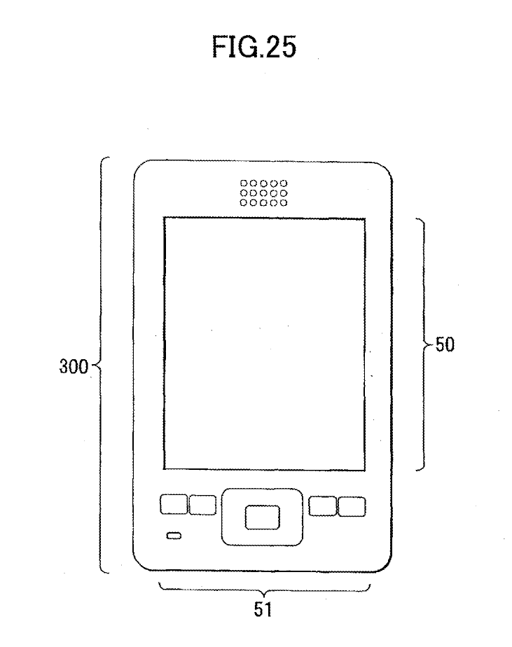

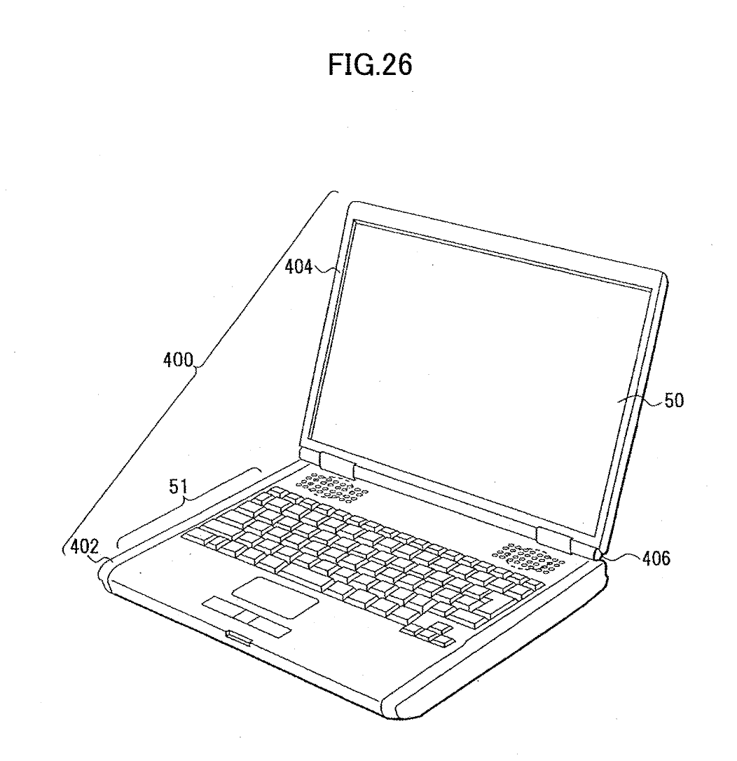

Namely, the communication terminal device in the present application may be any of appropriate devices that may use the wireless LAN and include, for example, a Personal Digital Assistant (PDA) 300 (FIG. 25) and a Personal Computer (PC) 400 (FIG. 26).

As illustrated in FIG. 26, the PC 400 may include a keyboard side chassis 402 and a display side chassis 404 openably connected with the keyboard side chassis 402 via a hinge 406. In FIG. 26, the same reference numerals are used to describe the same elements and the repeated description thereof is herein omitted.

According to an embodiment, a communication terminal device to be connected to an access point to conduct communications using voice/sound packet data includes a jitter monitor monitoring a jitter of the voice/sound packet data received from a connecting access point; and a handover cause generator generating a handover cause to change a connection from the connecting access point to another access point based on a number of jitters exceeding an allowable value in a predetermined time period.

According to an embodiment, a handover control method for a communication terminal device to be connected to an access point to conduct communications using voice/sound packet data, the handover control method includes monitoring a jitter of the voice/sound packet data received from a connecting access point; and generating a handover cause to change a connection from the connecting access point to another access point based on a number of jitters exceeding an allowable value in a predetermined time period.

According to an embodiment, a computer-readable executable program instructing a processor to perform the steps of monitoring a jitter of the voice/sound packet data received from a connecting access point; and generating a handover cause to change a connection from the connecting access point to another access point based on a number of jitters exceeding an allowable value in a predetermined time period.

A communication terminal device, a handover control method, or a handover control program may have the effects described below.

(1) The handover is executed in an area between the access points based on the jitter of the voice/sound packet data. Therefore, the voice/sound quality of the voice/sound data communication may be improved and the degradation of the voice/sound quality of the voice/sound data communication may be prevented (reduced).

(2) The handover is executed in an area between the access points based on the jitter of the voice/sound packet data. Therefore, the workload of the access points may be reduced and distributed.

(3) The number of handovers repeatedly executed due to the degradation of the strength of the radio waves being used as the reference (criteria) may be reduced when determining the execution of the handover. Namely, the number of unnecessary handover operations may be reduced, and a no-voice state due to the handover and the degradation of the voice/sound quality due to the handover may be prevented (reduced).

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of superiority or inferiority of the invention. Although the embodiments of the present inventions has been described in detail, it is to be understood that various changes, substitutions, and alterations could be made hereto without departing from the spirit and scope of the invention.

What is claimed is:

1. A communication terminal device to be connected to an access point to conduct communications using voice/sound packet data, the communication terminal device comprising:
a jitter monitor configured to monitor a jitter of the voice/sound packet data received from a connecting access point; and
a handover cause generator configured to generate a handover cause to change a connection from the connecting access point to another access point based on a number of jitters exceeding an allowable value in a predetermined time period.

2. The communication terminal device according to claim 1,
wherein the jitter monitor includes
a jitter detector configured to detect the jitter of the voice/sound packet data received from the connecting access point,
a timer configured to determine a time period when the number of the jitters is counted, and
a counter configured to count the number of the jitters exceeding the allowable value and being detected by the jitter detector in the predetermined time period.

3. The communication terminal device according to claim 1, further comprising:
a controller configured to execute a handover based on the handover cause generated by the handover cause generator,
wherein the handover to change the connection from the connecting access point to the another access point is executed by the controller.

4. The communication terminal device according to claim 1, further comprising:
a handover determinator configured to determine whether the handover is to be executed by using both the handover cause generated by the handover cause generator and a handover cause generated based on a strength of a radio wave, a retransmission rate of a transmission voice/sound packet data, or a signal-to-noise ratio from the connecting access point.

5. The communication terminal device according to claim 4,
wherein the handover determinator is configured to determine whether the handover is to be executed based on a logical AND condition of the handover cause generated by the handover cause generator and the handover cause generated based on the strength of a radio wave, the retransmission rate of a transmission voice/sound packet data, or the signal-to-noise ratio from the connecting access point.

6. A handover control method for a communication terminal device to be connected to an access point to conduct communications using voice/sound packet data, the handover control method comprising:
monitoring a jitter of the voice/sound packet data received from a connecting access point; and
generating a handover cause to change a connection from the connecting access point to another access point based on a number of jitters exceeding an allowable value in a predetermined time period.

7. The handover control method according to claim 6, further comprising:
detecting the jitter of the voice/sound packet data received from the connecting access point, and
counting the number of the jitters exceeding the allowable value and being detected by the jitter detector in the predetermined time period.

8. The handover control method according to claim 6, further comprising:
executing a handover to change the connection from the connecting access point to another access point based on the handover cause generated in the generating.

9. The handover control method according to claim 6, further comprising:
determining whether the handover is to be executed by using both the handover cause and another handover cause generated based on a strength of a radio wave, a retransmission rate of a transmission voice/sound packet data, or a signal-to-noise ratio from the connecting access point.

10. A non-transitory computer-readable storage medium with an executable program stored thereon, wherein the program instructs a processor to perform the following steps:
monitoring a jitter of the voice/sound packet data received from a connecting access point; and
generating a handover cause to change a connection from the connecting access point to another access point based on a number of jitters exceeding an allowable value in a predetermined time period.
